(19) United States
(12) Patent Application Publication
(10) Pub. No.: US 2023/0135611 A1
(43) Pub. Date: May 4, 2023

(54) Online Platform for Carbon Offsetting with Automatically Identified Impacting Measures

(71) Applicant: Compensate Operations Oy, Helsinki (FI)

(72) Inventors: Atte Kojo, Espoo (FI); Manuel González, Helsinki (FI); Leo Järvinen, Helsinki (FI); Annikki Laine, Helsinki (FI)

(73) Assignee: Compensate Operations Oy, Helsinki (FI)

(21) Appl. No.: 18/050,839

(22) Filed: Oct. 28, 2022

Related U.S. Application Data
(60) Provisional application No. 63/273,092, filed on Oct. 28, 2021.

(51) Int. Cl. G06Q 30/00; G06Q 10/06; G06Q 40/04

(52) U.S. Cl. CPC G06Q 30/018; G06Q 10/06375; G06Q 40/04

(57) ABSTRACT

Systems and methods are described for allocating Climate Impacting Measures (CIMs) on demand. A plurality of requests for CIMs may be received, where each request originates may include a desired emissions value. The requests may be aggregated into a batch having a total emissions value. A trained model may then be used to select CIM records and amounts of each selected CIM record based on CIM allocation rules, the batch emissions value, and optimization of an offset value in view of a cost associated with each selected CIM record. In some embodiments, further optimization may obtained using penalty functions and/or historical data from similar CIM record groups. Responses may then be transmitted to each of the plurality of requests, the responses each including a message for display on a graphic interface describing the allocated selected records for the requesting entity associated with the request.

### CROSS-REFERENCE TO RELATED APPLICATIONS

This application claims the benefit of U.S. Provisional Application No. 63/273,092, filed Oct. 28, 2021, which is incorporated herein in its entirety.

### TECHNICAL FIELD

The present disclosure generally relates to using artificial intelligence via a model to select a batch of climate impact measure records from a database in response to aggregated requests for climate impact measures, and in particular selecting records based on allocation rules and optimizing an offset value in view of a cost for each impact measure.

### SUMMARY

Systems and methods are described for allocating scientifically selected Climate Impacting Measures (CIMs) in an automated, scalable and recorded and/or monitored process to offset CO2e emissions or for creating Meta Carbon Credits. A processor of a computer having memory may receive a plurality of requests for CIMs over a network connection, for example. Each request may originate from a different requesting entity, and may include a desired emissions value and, optionally, user preferences associated with the requesting entity. The plurality of requests may be aggregated into a batch after being received. The batch may have an emissions value equal to the sum of the individual emissions values of the plurality of requests, and may be further associated with a set of user preference rules that include each of the user preferences associated with the requesting entities.

A trained model may then be applied to the aggregated plurality of requests to select CIM records from a database and amounts associated with each selected CIM record. The trained model may select CIM records based on CIM allocation rules and the batch emissions value, and may select CIM records by optimizing an offset value of each selected CIM record in view of a cost associated with each selected CIM record. Once the CIM records are selected for the batch, they may be allocated to the requesting entities based on the emissions values and the user preferences associated with each request. Responses may then be transmitted to each received request of the plurality of requests, the responses each including a message for display on a graphic interface describing the allocated selected records for the requesting entity associated with the request. Further embodiments involve the trained model evaluating a first set of CIM records using penalty functions and/or historical objective values of similar CIM record groups.

### BRIEF DESCRIPTION OF THE DRAWINGS

In the following drawings, like reference numbers are used to refer to like elements. Although the following figures depict various examples, the one or more implementations are not limited to the examples depicted in the figures.

FIG. 1 shows a simplified block diagram of a specific embodiment for a system for allocating CIMs using a trained model.

FIG. 2 shows a flow diagram for a specific embodiment of a method of allocating CIMs using a trained model.

FIG. 3 shows a simplified block diagram of a specific embodiment for a system for determining emissions values for CIM requests.

FIG. 4 shows a simplified block diagram of a specific embodiment for a system for assembling a CIM record database/pool.

FIG. 5 shows a flow diagram of a specific embodiment of a method of identifying a selected set of CIM records using a trained model.

FIG. 6 shows a simplified block diagram of a carbon market engine for selecting and allocating CIM records.

FIG. 7 shows a flow diagram of a specific embodiment of a method of selecting and allocating CIM records using a carbon market engine.

FIGS. 8A-B show the results of two runs of the trained model for selecting CIMs, according to an embodiment.

FIG. 9 shows the results of another run of the trained model for selecting CIMs, according to an embodiment.

FIG. 10 shows the results of another run of the trained model for selecting CIMs, according to an embodiment.

FIGS. 11A-B show the comparisons of a scaled objective value of a set of selected CIM records with historical data, according to an embodiment.

FIG. 12 depicts a block diagram illustrating an exemplary computing system for execution of the operations comprising various embodiments of the disclosure.

### DETAILED DESCRIPTION

A software platform for calculating and/or estimating CO2e emissions and/or Offsetting them individually or in aggregate for any Item (such as a specific product, service or activity), for taking other action to reduce the amount of CO2e in the atmosphere, or for creating Meta Carbon Credits for another purpose, on-demand through the allocation of scientifically selected Climate Impacting Measures (CIM) in an automated, scalable and recorded and/or monitored process is described herein. These impact measures are received, and in response to the impact measures being approved, may be added to a persistent storage (CIM Pool) containing CIM data, including each CIM's Offset Value (OV) and other characteristics such as type, method and region of the CIM. A User Order in the form of a selection is received by an Emission Calculations Engine (ECE) for processing. The selection may include Items and other Emission Value (EV) inputs for assessment by the ECE. The selection may be accompanied by User Preferences.

The Emission Calculations Engine (ECE) may calculate an aggregate Emission Value on the basis of the User Order. This may be done by retrieving stored carbon footprint values for each Item in the selection and by receiving other EV inputs within the selection; by determining an EV for each of the foregoing based on the retrieved EVs and other inputs; and by aggregating the individual EVs as an aggregate EV for the User Order.

A Carbon Market Engine (CME) may then receive the aggregate EV data of one or several User Orders and, upon initiating a CME Transaction which includes all such User Orders, transform them into a EV Batch equal to the sum of all aggregate EVs so received. The inclusion of User Orders into a CME Transaction may be realized by applying artificial intelligence and received rules. By employing artificial intelligence, the CME may select, within received rules and preferences, CIMs from a CIM Pool and allocate variable amounts of CIM Units received from the CIMs to aggregate an OV Batch on the basis of the proportional Offset Value of such CIM Units, said OV Batch being equal to the corresponding EV Batch. The selection of CIMs and the allocation of variable amounts of CIM Units may be realized by applying received CIM Allocation Rules and User Preferences. The CME may then select a subset of CIMs from the CIM Pool based on their respective Internal Factors and/or External Factors using a trained model for selecting CIMs, and assign optimal variable amounts of CIM Units from such CIMs to maximize the Objective Value of the OV Batch within received constraints.

The CME may also further optimize the OV Batch by applying received Penalty Functions. The aim of the CME is to maximize the Objective Value of CME Transactions over time to ensure optimal climate impact (maximal ObV/monetary unit). Upon arriving at an optimal OV Batch, the CME may transform the CIM Units in the OV Batch into corresponding Meta Carbon Credits (and/or fractions thereof) and assign them in proportional amounts to the User Orders in the CME Transaction to satisfy their respective aggregate EVs and thereby to realize the Offsetting of the Items and other emission inputs and/or to create Meta Carbon Credits for another purpose as requested in the relevant User Orders. In exemplary embodiments, a report may be generated based on the selected subset of CIMs for reporting to User(s), the Platform Operator, CIM Supplier(s) and/or another parties such as carbon market registries.

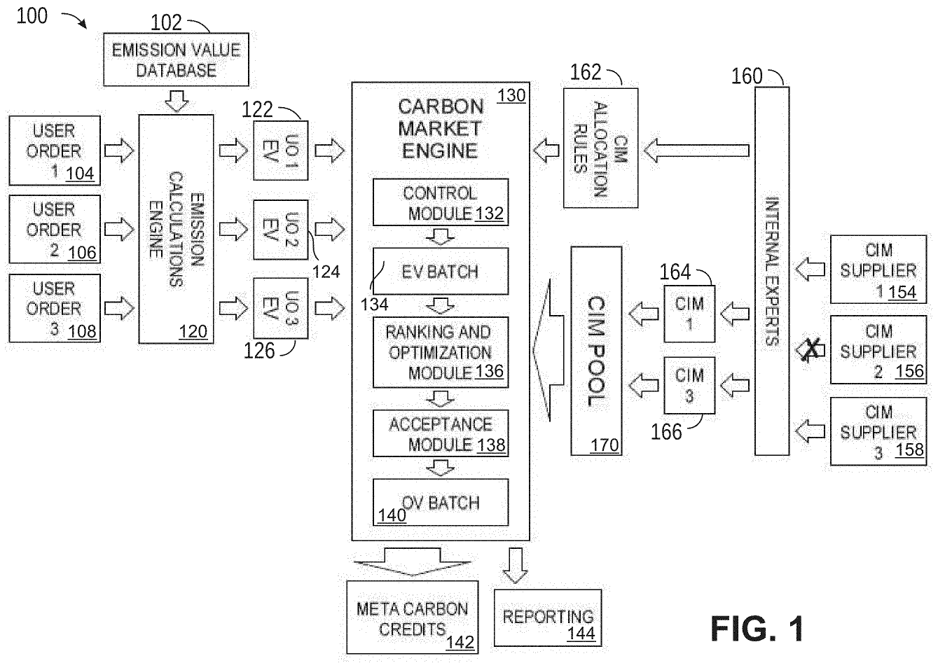

FIG. 1 shows a simplified block diagram of a specific embodiment for a system 100 for allocating CIMs using a trained model. The system 100 may include emissions calculation engine 120, carbon market engine 130, and CIM pool/database 170. The emissions calculation engine 120, carbon market engine 130, and CIM pool/database 170 may be communicatively coupled to each over via a network connection (i.e. using a local network or a remote network, such as the Internet). The platform 100 allows users to offset CO2e emissions (also known as greenhouse gas emissions) arising from items, such as a product that they have produced, sold or purchased, or a business activity or life activity that they have partaken (e.g. an airplane flight). The items may be included in requests for CIMs 104, 106, 108 transmitted by requesting entities. The platform 100 is capable of calculating or estimating carbon footprints for the items of the requesting entities, based on their intrinsic characteristics, by way of a methodology that adheres to the applicable scientific and industry standards. To this end, the platform 100 may include a collection of predetermined carbon footprints, in emission value database 102, as emission values for items, calculated or estimated using proprietary and scientific methods. The emissions calculation engine 120 may estimate the carbon footprints of Items on the basis of the items' characteristics or qualities by using categorical Emission Values or Emission Values of similar Items, or may receive the Emission Values of Items from other sources, resulting in emission value estimates 122, 124, and 126.

Apart from the foregoing, the Platform may receive from Users (who want to take other action to reduce carbon emissions in the atmosphere) Emission Value inputs as numerical values, which are not connected to any particular Item in the CIM requests 104, 106, 108. The platform 100 may also receive, as part of the CIM requests 104, 106, and 108 to create Meta Carbon Credits for another purpose (such as wholesale distribution or trading of such credits). In addition to the foregoing capabilities, the Platform may contain a selection of carefully selected and scientifically evaluated Climate-Impacting Measures (CIMs), which it breaks down computationally into fractional CIM Units and recompiles them into Meta Carbon Credits (and/or fractions thereof) in corresponding proportions. The MCCs are, in turn, instrumental to Offsetting emissions arising from Items; to realizing other climate action intended by the User; or for any other purpose supported by the Platform.

From the user's viewpoint, the platform 100 can be accessed and used to buy Meta Carbon Credits (and/or fractions thereof) 142 to directly offset CO2e emissions arising from any items that may be relevant to the user's business, consumption or various operations and activities. Additionally, the User may buy MCCs (and/or fractions thereof) that are not connected to any specific items, in order to take positive action for the climate or for another purpose. Furthermore, the platform 100 can be connected to an external sales channel such as a third-party web store or a cash register system, in order to allow for offsetting and/or purchasing of MCCs (and/or fractions thereof) through such channels. Finally, the platform 100 can be accessed and used internally (by human or a computer-based process) to create MCCs 142 (and/or fractions thereof) for any purpose.

The platform 100 provides an automated process that saves the user the trouble of calculating CO2e emissions arising from any items, and looking for reliable CIMs to offset those emissions, to take other climate action and/or to purchase or create high-quality MCCs with measured and verified climate impact. In one possible embodiment, the platform 100 offers a web store-like user experience. By accessing and using a website-operated platform, the user may collect any number and combination of items in a “shopping cart” for calculating their CO2e emissions; may input a freely chosen Emission Value (EV) to take climate action not connected to any item; and/or input a freely chosen amount of Meta Carbon Credits (and/or fractions thereof) to purchase or create for another purpose supported by the platform 100. In an alternative embodiment, the user may do the foregoing by way of a mobile application. In yet another possible embodiment, the user or its users (e.g. end customers) can do the same by way of an application programming interface (API) or other computer software, which enables access to the Platform as described in the foregoing in an external location (including but not limited to the user's own website or web store, mobile application or point of sale (POS) system). The platform 100 may also be accessed and used through other embodiments not described herein. In all embodiments, the User may be able to further define the items to reflect their actual characteristics (e.g., in case of air travel offsetting, entering the start and endpoints of travel, travel class, etc.). The User may be able to include with their CIM requests 104, 106, and 108 certain user preferences to favor certain CIMs or CIM methods, types, regions or other characteristics over others when Offsetting Items, taking other climate action and/or purchasing or creating MCCs (and/or fractions thereof) for another purpose. Based on the user inputs in the CIM requests/User Orders 104, 106, and 108 and emissions value database 102, the emissions calculations engine 120 may calculate EV values for each CIM request, resulting in determined EV values 122, 124, and 126 corresponding to the User Orders 104, 106, and 108.

Based on the items and/or values included in the CIM requests, the platform 100 will use the carbon market engine 130 to allocate CIMs. The control module 132 may be used to determine the Emission Values arising from Items and add them up with any other EV input by the User (any amount of MCCs (and/or fractions thereof) input by the User will be also converted into a corresponding EV) to calculate an aggregate Emission Value for the User Order. The carbon market engine 130 will then compile an EV Batch 134 from one or several aggregate EVs 122, 124, and 126 received from User Orders 104, 106, and 108 included in a single CME Transaction. Next, by applying artificial intelligence, the Platform will conduct processes and employ methods to allocate variable amounts of CIM Units from CIMs selected by it within received rules and preferences using optimization module 136 and acceptance module 138.

The CIM records and amounts may be selected from CIM pool/database 170. The CIM database 170 may be derived using internal experts 160, who may apply CIM evaluation rules to allow CIM records, such CIM 1 164 (provided by by CIM supplier 154) and CIM 3 166 (provided by CIM supplier 3 158) to be added to the CIM database 170. The CIM provided by CIM supplier 2 156 may have been rejected for failing to meet the CIM evaluation rules, as indicated in FIG. 1. The internal experts 160 may also create, prior to running of the carbon market engine 130, CIM allocation rules 162 used for the selection of the CIMs by the trained model. Generation of the CIM database 170 and CIM allocation rules 162 is described in greater detail below.

Upon allocating such CIM Units, the carbon market engine 130 will compile an OV Batch 140 which offsets the batch EV value associated with the EV Batch 134 in the CME Transaction. At that stage, the carbon market engine 130 will run any applicable Penalty Functions to test the feasibility of the OV Batch against received rules and preferences, and it will apply OV-reducing penalties for any deviations. The aim of the carbon market engine 130 is to prepare an OV Batch 140 with an optimal Objective Value, which is the measure of the quality of the OV Batch within received constraints. Finally, the Platform will convert the CIM Units in the optimal (ObV-adjusted if applicable) OV Batch into Meta Carbon Credits (and/or fractions thereof) 142 and issue and assign such credits to the User Orders in the CME Transaction. As a result of such issuance and assignment, the MCCs (and/or fractions thereof) will be uniquely assigned to the corresponding User Orders and the CME Transaction will have been concluded, which the Platform will record in a permanent way and may report to relevant parties using module 144. As a result of the steps and processes described in the foregoing, the User will have purchased uniquely identifiable MCCs (and/or fractions thereof) for the purposes of Offsetting of Items and/or of taking another climate action unconnected to any Items, and/or for other purpose supported by the Platform.

Within the steps and processes described in the foregoing, the only action required from the User is to choose the Items (and further define them as described in the foregoing, if available) that they wish to Offset, or to input a freely chosen Emission Value or a freely chosen amount of MCCs (and/or fractions thereof) to purchase or create for other purposes, and to submit the User Order. The User is not required to have knowledge of how CO2e emissions are scientifically determined and calculated, and the User is not required to do any emission calculations by itself. Also, the User does not have to understand the qualitative differences between various Carbon Credits or CIMs in the carbon market (e.g. the reliability, measurability and biodiversity and community impact of various CIMs). Instead, the Platform facilitates scientifically approved carbon Offsetting in as optimal manner as possible (within constraints as described in the document) to maximize the aggregate Objective Value per monetary unit spent on various CIMs across CME Transactions over time and therefore deliver optimal climate impact for the price, in an automated, scalable and easily accessible process for the User.

The following terms are used throughout this document:
Business Activity: any process or a part thereof carried out by a User as part of its business, including but not limited to sourcing, manufacturing, shipping, administrative processes, marketing, employee travel, and office and building maintenance. The term also includes any Scope 1, 2 or 3 process, operation or activity described in the Greenhouse Gas (GHG) Protocol.
CO2e: (carbon dioxide equivalent) an umbrella term used in the carbon market to mean carbon dioxide, and to mean any other greenhouse gas and any other particles that have a similar effect on the atmosphere as carbon dioxide, expressed in an equivalent amount of carbon dioxide.
Carbon Credit (CC): a generic term used in the carbon market to mean a tradeable certificate representing 1000 kilograms (1 metric ton) of CO2 removed or sequestered from the atmosphere or said gases prevented from being emitted into the atmosphere.
Carbon Market Engine (CME): the engine within the Platform that, as described in this document, employs artificial intelligence and/or machine learning to carry out CME Transactions, and to report the results of the transactions as well as to receive data and feedback on the successfulness of the transactions and other information in order to adjust and optimize certain data in the Platform and its usage of CIM Allocation Rules and User Preferences in future transactions.
Climate impacting Measure (CIM): a project or another measure carried out by a CIM Supplier that has the effect of removing or sequestering CO2 from the atmosphere or preventing the emission of said gases into the atmosphere.
CIM Pool: a persistent storage (e.g. database) within the Platform that contains relevant CIM data such as each CIM's OV, and other External Factors such as CIM type, method and region and Internal Factors such Climate Integrity Score, Community Impact Factor and Failure Risk Factor (there are defined later in the document).
CIM Supplier: a person or entity who operates a CIM and issues Carbon Credits therefrom.
CIM Unit: a computational value representing a variable fraction of a Carbon Credit from a given CIM. While a purchase and retirement of Carbon Credits in the carbon market can only be done in terms of full Carbon Credits, the Platform will split up (computationally) such full credits into representative CIM Units and allocate them across one or several User Orders within one or several CME Transactions. By default, each CIM Unit=1/1000 CIM.
   Example: the User wishes to Offset an aggregate EV equaling only 100 kg of CO2e emissions. Because the need is less than a full Carbon Credit (1000 kg CO2), only 100 CIM Units (equaling 0.1 of a Carbon Credit) are allocated to this User Order.
CME Transaction: a process wherein the Carbon Market Engine of the Platform conducts the steps and employs the methods described in this document with the effect of receiving one or several User Orders as selections, preparing an EV Batch equal to the sum of the aggregate EVs of such selections, selecting and allocating variable amounts of CIM Units from one or several CIMs in the CIM Pool as an OV Batch to correspond to the EV Batch, transforming the OV Batch into an equal amount of Meta Carbon Credits (and/or fractions thereof), and issuing and assigning the relevant MCCs (and/or fractions thereof) to the User Orders within the CME Transaction in proportional amounts with the effect of Offsetting, of taking of other climate action or of creating MCCs (and/or fractions thereof) for any purpose as requested in the relevant User Orders.
Emission Calculations Engine (ECE): the engine within the Platform that, as described in this document, receives from the User a User Order to Offset CO2e emissions arising from Items, to take other action to reduce the amount of CO2e in the atmosphere, or to create Meta Carbon Credits for another purpose. On the basis of the User Order as a selection, the ECE assesses the emission values of each Item and other emission inputs, and calculates the aggregate Emission Value for them.
Emission Value (EV): a value, in fraction of 1000 kg CO2e, assigned to an Item to represent its carbon footprint or other effect of adding CO2e into the atmosphere; also a value input by the User (who wants to take action to reduce CO2 in the atmosphere) not connected to any particular Item; also a value corresponding with the Offset Value of Meta Carbon Credits that the User wishes to create. The “aggregate EV” may to the sum of all EV inputs within a single User Order.
   Example 1: the production chain of a specific television set (Item) causes the emission of 500 kg CO2e into the atmosphere. The Emission Value of the Item is EV=500.
   Example 2: the User wishes to take action to reduce 2000 kg of CO2 in the atmosphere. The Emission Value input by the User is EV=2000.
   Example 3: the User wishes to buy 4 MCCs. Each MCC representing 1000 kg of CO2 in the atmosphere, the Emission Value input by the User is EV=4000.

In this User Order, the aggregate EV=500+2000+4000=6500.
EV Batch: the sum of aggregate EVs received from all User Orders in a single CME Transaction, such sum to be calculated by the Carbon Market Engine based on the User Orders received as selections from the Emission Calculations Engine.
Item: any product, service or Business Activity or Life Activity, or any other tangible or intangible item, or any amount and combination of the foregoing, the CO2e emissions arising from which may be Offset by way of the Platform.
Life Activity: any process or a part thereof carried out by a User as part of its daily or non-daily life, including but not limited to consumption, living arrangements, family life, dietary preferences, travel and hobbies.
Meta Carbon Credit (MCC): a term used in the Platform to denote and concretize a collection of CIM Units representing at least 1000 kilograms (1 metric ton) of CO2. While a Carbon Credit is a unit issued by a CIM in the carbon market, a MCC is a carbon credit “re-packed” by the Platform from variable amounts of CIM Units from one or several CIMs. Each MCC serves as a certificate to warrant and represent that at least 1000 kilograms (1 metric ton) of CO2 has been removed or sequestered from the atmosphere or said gases prevented from being emitted into the atmosphere. Every MCC can be divided up into computational fractions, each fraction representing the proportional climate effect of the MCC (e.g. 20/1000 MCC means that the fractions of MCC represent 20 kilograms of CO2 removed or sequestered from the atmosphere or said gases prevented from being emitted into the atmosphere).
Objective Value (ObV): the numerical value calculated by the Carbon Market Engine by way of applying received Penalty Functions, which is returned as the ObV-adjusted aggregate OV of a given OV Batch. The aim of the CME is to minimize the effect of Penalty Functions and therefore maximize the ObV of CME Transactions over time, thus optimizing the ObV/monetary unit ratio across all transactions.
Offset (CO2e emissions): the act of purchasing and retiring Carbon Credits with the effect of removing or sequestering CO2 from the atmosphere or preventing the emission of said gases into the atmosphere, so as to make good the emission of CO2e into the atmosphere that has taken place or will take place in the future. As an industry standard, in order for a specific amount of CO2e emissions to be considered Offset, a corresponding amount of Carbon Credits must be purchased and retired. Through their retirement, the Carbon Credits are removed from the carbon market permanently and they are deemed as “used up” to Offset an equal amount of CO2e emissions. The term also encompasses “(CO2e) compensation” and other identical or similar industry terms used in the carbon market.
Offset Value (OV): a value, in kg CO2e, assigned to a certain CIM to represent its effect of removing or sequestering CO2 from the atmosphere, or preventing the emission of said gases into the atmosphere, for an investment of 1 monetary unit. Where a CIM is split up into CIM Units, each CIM Unit retains a proportional OV.
   Example: sequestering 1000 kg of CO2 from the atmosphere through a specific CIM costs $20. The CIM has been assigned an OV of 860, which means that the Platform's internal experts have evaluated one Carbon Credit from that CIM to sequester in reality 860 kg of CO2e in the atmosphere (even though it is being marketed by the CIM Supplier as doing so at 1000 kg). The CIM is split up into 1000 CIM Units, each CIM Unit representing 1/1000 CIM and costing $20/1000=$0.02. The OV of a CIM Unit is OV=860/1000=0.86.
   To Offset the EV of the television set mentioned above (EV=500), 581 CIM Units are needed (500 EV/0.86 OV≈581). In this case, the Offsetting costs $ 0.02*581=$11.62.
OV Batch: an aggregate OV prepared from a variable number and composition of CIM Units in the CIM Pool to match the corresponding EV Batch with the effect of Offsetting, of taking of other climate action or of purchasing or creation of MCCs (and/or fractions thereof) for any purpose.
Platform: any website, mobile application or application programming interface (API) or any other computer software, whether recorded or downloadable, through which the invention may be accessed and used by the User to purchase or create Meta Carbon Credits for the purposes of Offsetting Items and/or of taking other climate action, and/or for other purposes supported by the Platform.
Penalty Functions: the functions that are received by the CME to monitor that the outcomes of a CME Transaction remain within set boundaries as described in this document. Within each CME Transaction, the CME applies penalty deductions in accordance with the Penalty Functions to the aggregate OV of an OV Batch whenever the batch does not conform to relevant constraints such as CIM Allocation Rules and User Preferences (if applicable). As a result, a batch that would otherwise seem optimal, may see its aggregate OV reduced so much that it becomes infeasible as an acceptable OV Batch. Upon applying the Penalty Functions the aggregate OV of the OV Batch is (re-adjusted to match the Objective Value (ObV).
User: any company, organization, entrepreneur, consumer or another legal or natural person accessing and using the Platform for the purposes of choosing Items and Offsetting the CO2e emissions arising from them, or of taking another climate action. The term may also include any internal user or any computer process making use of the Platform in order to select and allocate CIM Units for the purposes of compiling MCCs for any purpose whatsoever.
User Order: an order placed by a User in the Platform to Offset a given amount of CO2e emissions or to take another climate action, or to create MCCs (and/or fractions thereof).
User Preference: a choice entered by the User in the Platform as part of the EV Order to prefer, insofar as available, specific CIMs or various CIM characteristics including but not limited to CIM types, methods, geographical locations.
   Example: a User may enter a User Preference for CIMs facilitating carbon removal (type=“removal”), using reforestation (method=“reforestation”), located in North America (region=“North America”).

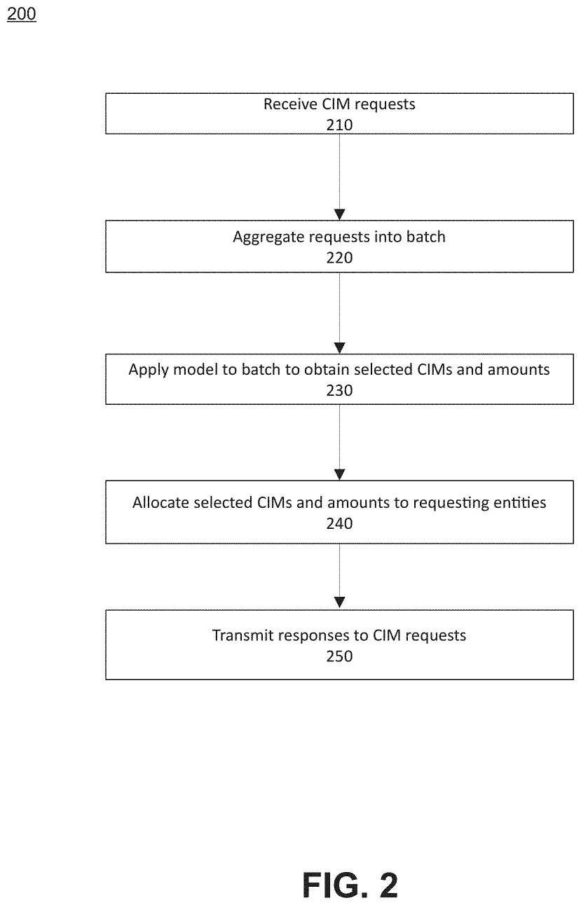

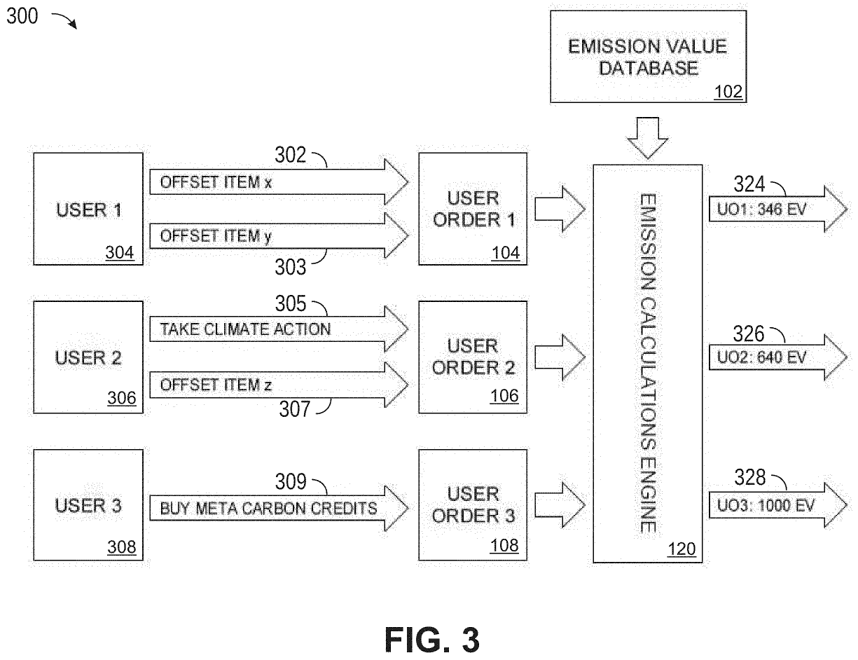

FIG. 2 shows a flow diagram for a specific embodiment of a method 200 of allocating CIMs using a trained model. A processor of a computer having memory may receive a plurality of requests for CIMs at step 210 over a network connection, for example. Each request may originate from a different requesting entity, and may include a desired emissions value and user preferences associated with the requesting entity. As noted above, the desired emissions value may be directly included in each request, or may be calculated using, for example, an emissions calculation engine. FIG. 3 shows a simplified block diagram of a specific embodiment for a system 300 for determining emissions values for CIM requests. When placing one of user orders 104, 106, or 108, to calculate and/or offset CO2e emissions, the respective user 304, 306, or 308 may select the item(s) for doing so (“the Selection”). If available, the user may also further specify the Item(s) to reflect their actual characteristics (e.g. in case of air travel offsetting, the points of travel, travel class etc.). For example, user 304 may select offset item x 302 and offset item y 303 and include the selected offset items in user order 104.

Additionally or alternatively, the user may place a user order for an arbitrary amount of CO2e emissions (not connected to any Item) in order to take other climate action, such emissions also to be included in the Selection. This is shown in system 300, where user 306 has selected climate action 305 in addition to offset item z 307 for inclusion within CIM request 106. Also, the user may simply enter an amount of meta carbon credits (and/or fractions thereof) to purchase without immediate intention to Offset or to take other climate action, as user 308 has done with MCC request 309 included within CIM request 108. When making its Selection, the User may finally specify preferences as to the type, method, geographical region or similar characteristics of CIMs as user preferences (if available) for inclusion with CIM requests 104, 106, and 108. Once completed, the Selection, together with User Preferences, is passed on to the Emission Calculations Engine 120.

The Emission Calculations Engine (ECE) 120 calculates the aggregate EV for the Selection. To do this, the engine may retrieve specific Emission Value data in its database 102 on certain Items. These data may have been received directly from the Item suppliers (e.g product manufacturers or service providers), from this or other Users, from research or from other sources (e.g. public or commercial climate impact indices). If no specific EV data exist on a certain Item the engine may apply EV estimates made on the basis of the characteristics of the Item or categorical types thereof. These estimates may have been received from external CO2e emission indices, from research or from other sources. The estimations adhere to industry practices and employ expert knowledge on the probable emission effects of certain Items or types of Items. These estimations exist in the ECE's database 102 as placeholders as long as no specific data is available.

In addition, if no directly applicable estimates exist in the database, the ECE 120 may combine general Item information (e.g. country of origin, manufacturing materials, country of service performance, manner of travel, usage of green electricity etc.) to liken a certain Item to a specific data item or estimate existing in the database 102. If necessary, the Platform may ask the User to input some data of this kind as part of the User Order. However the emission value for each CIM request is determined, it is output by the ECE 120, as shown by emission values 324, 326, and 328 being computed for CIM requests 104, 106, and 108 respectively.

In case of taking climate action not connected to any Item or of the direct purchasing of MCCs (and/or fractions thereof), the ECE processes the values input by the User in the User Order as such and issues them a corresponding EV (e.g. 1 kg CO2e=1 EV). The engine then adds up all EVs calculated or estimated or assigned as the aggregate EV of the individual User Order.

Once the EV for the individual User Order/CIM request has been prepared in accordance with the foregoing, the ECE 120 passes the value on to the Carbon Market Engine together with any User Preferences. The Selection passed on to the CME also contains data on the available funds (i.e. the money allocated by the Users in their User Orders).

Returning to method 200, the plurality of CIM requests may be aggregated into a batch at step 220 after being received. The batch may have an emissions value equal to the sum of the individual emissions values of the plurality of requests, and may be further associated with a set of user preference rules that includes each of the user preferences associated with the requesting entities. A trained model may then be applied to the aggregated plurality of requests at step 230 to select CIM records from a database and amounts associated with each selected CIM record. The trained model may select CIM records based on the CIM allocation rules and the batch emissions value, and may select CIM records by optimizing an offset value of each selected CIM record in view of a cost associated with each selected CIM record.

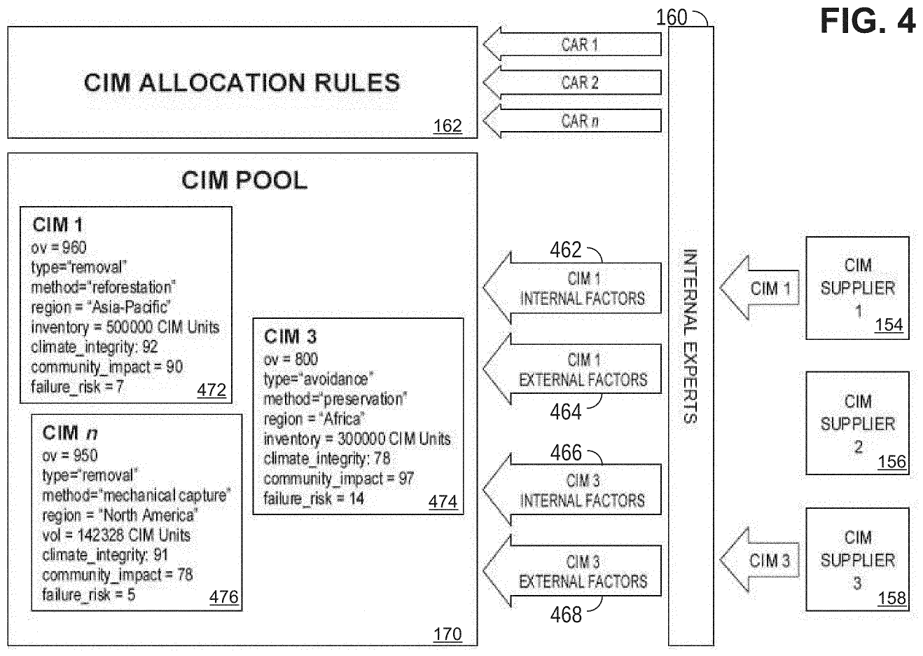

As noted above, the trained model may select the CIM records from a CIM pool/database. FIG. 4 shows a simplified block diagram of a specific embodiment for a system 400 for assembling a CIM record database/pool 170. Various CIMs are included in and excluded from the Platform, from time to time, by way of evaluation and selection conducted by the Platform operator. As shown in platform 100 and system 400, CIMs from suppliers 154 and 158 may be selected for inclusion in the CIM database 170, while the CIMs from supplier 156 may be excluded. Once approved by the operator's internal experts 160, CIMs included in the Platform are entered into the Platform's CIM Pool 170. As part of the entry into the CIM Pool 170, data specific to the CIM is recorded in the CIM Pool as External Factors (e.g., CIM 1 external factors 464 and CIM 3 external factors 468). The External Factors may contain, for example, information on the CIM's type, geographical region, start date, duration and number of Carbon Credits at disposal. (Upon entry into the pool, the amount of Carbon Credits received from a given CIM is converted into a computational inventory of CIM Units.)

As part of the evaluation and inclusion process, CIMs are evaluated by the Platform operator's internal experts 160 using selection criteria set by the operator. CIMs that pass the evaluation are added to the CIM Pool 170. The evaluators may score the CIMs using a scoring system developed by the operator. The scores received by each CIM reflect its scientifically approved, measurable and verifiable impact on the climate. All scores are recorded in the CIM Pool as Internal Factors, such as CIM 1 internal factors 462 and CIM 3 internal factors 466, for each CIM. The Internal Factors may contain for example:
Offset Value
Climate Integrity Score (reliability, status of verification etc.)
Community Impact Factor (positive effects in the community carrying out the CIM with indirect effect on the climate)
Failure Risk Factor (the likelihood of the CIM failing to deliver its intended climate impact over its life cycle)
   The Internal Factors of any CIM may be updated by the experts (and/or by the Meta-Optimization Logic as described in this document) from time to time. The internal experts 160 may also review CIM records, such as CIM 1 472, CIM 3, 474, and CIM n 476 included in the CIM database 170 from time to time, and once the criteria for inclusion are no longer met, may remove the CIM record from the database 170. As shown in system 400, each CIM record in the CIM database 470 may include its internal and external factors as identified by internal experts 160.

Internal experts 160 may set overarching CIM allocation Rules (CARs) 162 that apply to all CME Transactions. These rules depend on the Platform operator's standing sustainability policies, including overcompensation factors applicable to all CME Transactions, risk management policies as well as critical re-estimation of OV claims made by CIM Suppliers. For example, one CAR could be for example that no transaction may include more than 20% of CIM Units received from a single CIM. Another CAR could be that each CME Transaction must include CIM Units from at least two CIMs located in different continents. Yet another CAR could be that no transaction may contain more than 5% CIM Units from CIMs with a Failure Risk Factor of over x.

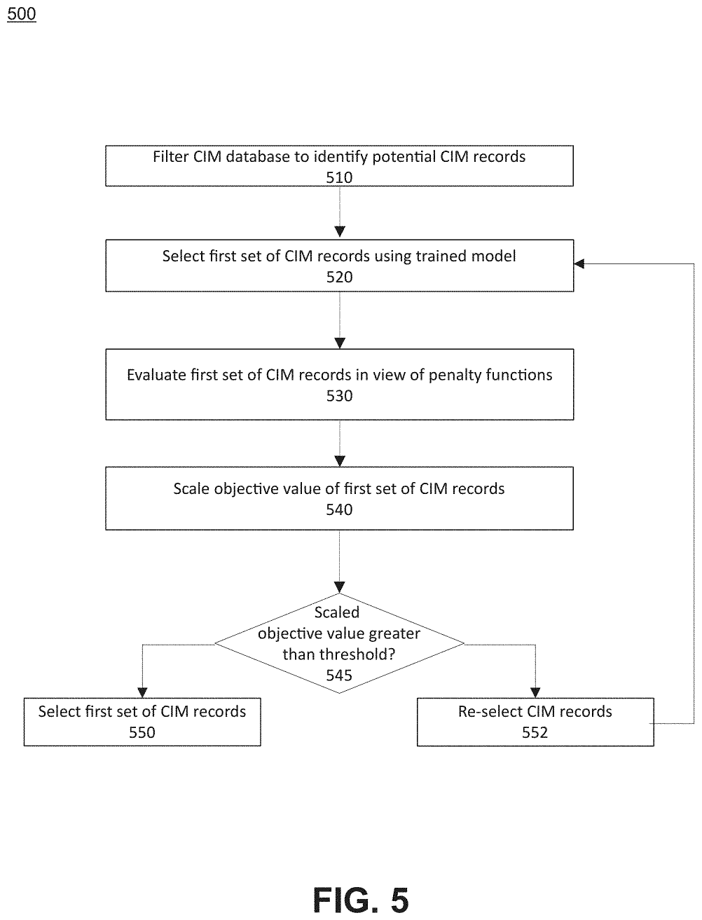

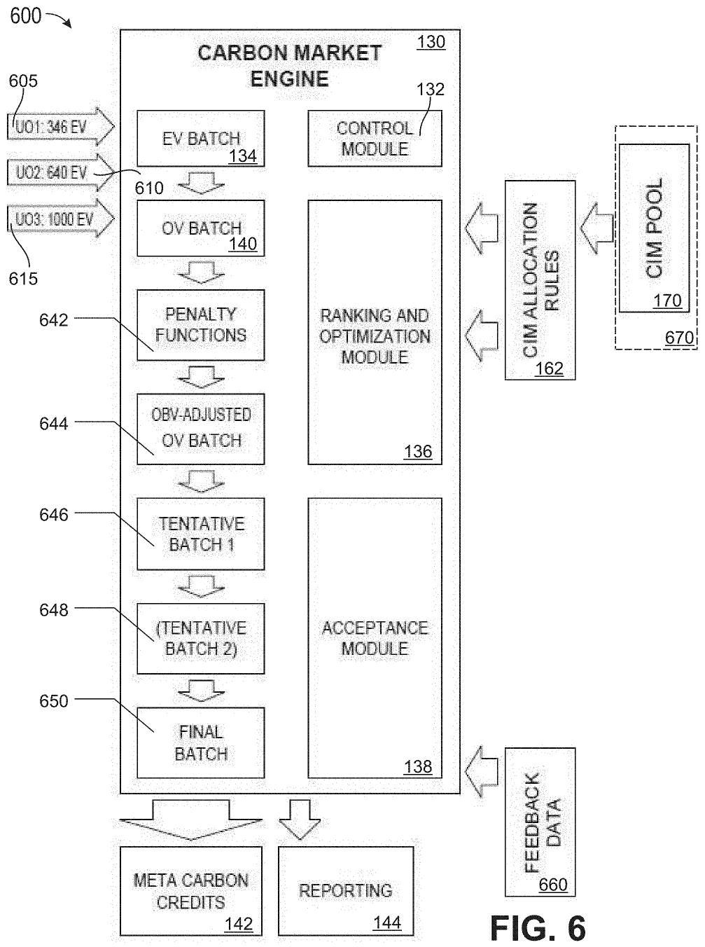

FIG. 5 shows a flow diagram of a specific embodiment of a method 500 of identifying a selected set of CIM records using a trained model. FIG. 6 shows a simplified block diagram of a system 600 including a carbon market engine 130 for selecting and allocating CIM records. The Carbon Market Engine (CME) 130, having received the EV data and any User Preference data from the ECE, combines the aggregate EV from this User Order with other aggregate EV data from all User Orders within set constraints (e.g. orders received during a predetermined time frame) to create an EV Batch 134 on the basis of the sum of aggregate EVs of all such User Orders.

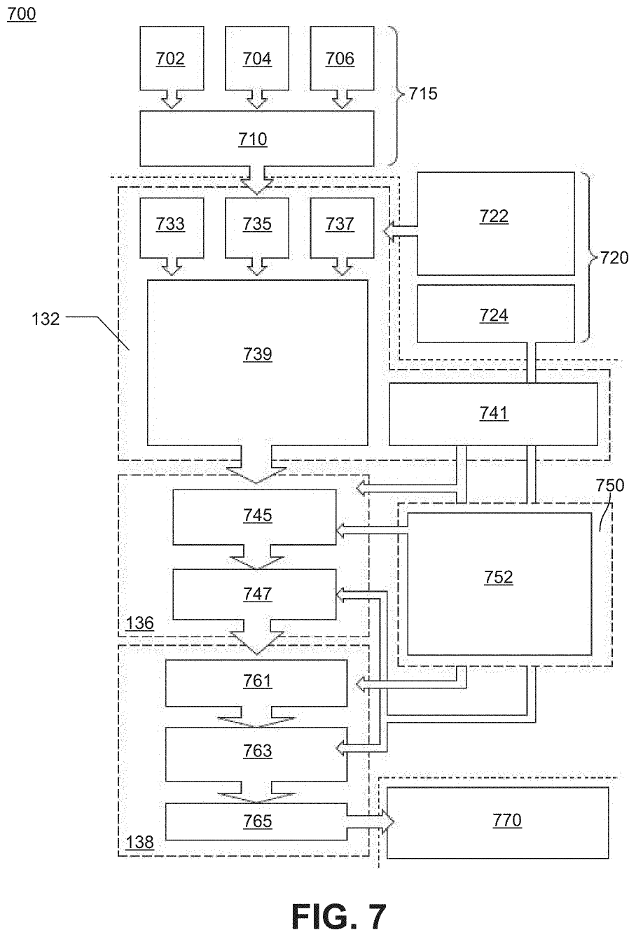

Thereafter, the CME 130 prepares a corresponding OV Batch 140 from CIM records in the CIM Pool 170 to match the EV Batch 134 as follows. In the first step, the engine filters out CIMs whose External Factors do not conform to applicable CIM allocation Rules and, insofar as feasible, to the user preferences at step 510. In an exemplary embodiment, user preferences are secondary to the CIM allocation rules, and it is feasible to apply user preferences (in the form of user preference rules, see the example depicted in FIG. 7 and the accompanying text) after the CIM allocation rules have been met. If applying the user preferences would contradict applicable CIM allocation rules, or would otherwise lead to a lower ObV/price value for the batch, the user preferences would become infeasible, and the CME 130 would not apply them as user preference rules. In the second step, the CME employs artificial intelligence to choose from the remaining CIMs and to allocate a variable amount of CIM Units from each chosen CIM to prepare an OV Batch at step 520.

Once a preliminary OV Batch is prepared, the CME (re-)tests the adherence of the OV Batch to received penalty functions at step 530. The purpose of the examination is to ensure that the batch, once compiled, is not contrary to the overarching rules set by the Platform operator. Every CAR is typically accompanied by an individual Penalty Function. If the OV Batch does not conform to the CAR, the engine applies received penalty factors (e.g. multiplier of −0.05) 642 to the batch's OV 140 (or to a portion of it in case of a CAR with a limited scope) to calculate an Objective Value 644 at step 540. Following received rules and principles, the aggregate OV of the OV Batch may be replaced by the ObV. In such case, the effective OV of the batch is reduced, which may then lead the CME to abandon the batch and compile a new batch with a higher ObV.

For example, consider a CME Transaction based on the following selected CIMs:
CIM1: type=“avoidance”; method=“forest protection”; region=“South America”; climate_integrity_score=82; price=$10.50; OV=670
CIM2: type=“removal” method=“reforestation”; region=“Asia-Pacific”; climate_integrity_score=84; price=$12.50; OV=845
CIM3: type=“removal” method=“mechanical capture”; region=“North America”; climate_integrity_score=95; price=$25.75; OV=1115
   CIMs using reforestation and/or forest protection as a method typically have a lower price per tCO₂, but they are usually marked with higher uncertainty (due to e.g. forest fires and other natural disasters) and lower permanence (due to e.g. using living trees in a partially controlled environment as carbon storage). In addition, such CIMs typically score lower on verification due to the difficulty of independently verifying the planting and long duration of growing trees. Therefore, the OV of such CIMs is normally lower. CIMs using mechanical carbon capture as a method, on the other hand, often have a higher price per tCO₂ but also better permanence and reliability. Also verifying the results of mechanical capture by third parties is easier, which usually results in higher verification scores. Therefore, CIMs based on mechanical carbon capture normally have a higher OV.

Apart from Climate Integrity Scores, Failure Risk Factors and other scores affecting the OV of the CIM (and therefore ensuring over time that lower quality and higher risk CIMs will have limited weight in any CME Transaction), to avoid unmanageable risks in individual CME Transactions the internal experts may have also set CIM allocation Rules to make sure that the CME will not compile an OV Batch consisting solely or to a great extent from lower quality and/or higher risk CIM Units. The CARs may therefore act as a safety net from a risk management point of view. Thus, the following CAR might be set to apply to all CME Transactions:
CAR1: The weighted average “Climate Integrity Score” of every OV Batch must be at least 84; Penalty factor: −0.10.
   While there may also exist a soft rule that User Preferences should be attempted to be met, such preferences may not be given precedence over the applicable CARs. By default, User Preferences do not carry penalty factors, although it is possible to assign penalties to them as well. In case of a conflict, the Platform will first and foremost satisfy any applicable CARs.

As a result of the foregoing processes and considerations the Carbon Market Engine may identify an allocation that satisfies the applicable CARs and user preference rules while maximizing the aggregate OV of the CME Transaction. This process may also take into account the maximum available CIM Units per OV (Internal Factor pertaining to CIM Pool inventory management), minimum allowable amount of CIM Units to allocate (External Factor set e.g. by the CIM Supplier) and any possible volume purchase discounts that might be applied (External Factor set e.g. by the CIM Supplier). After completion, the allocation in a single CME Transaction could result in a lower (ObV-adjusted) OV than would result from a more straightforward allocation, but it is more likely that average (ObV-adjusted) OV across multiple CME Transactions would be optimized over time.

When considering that in operation the Platform would typically have a CIM Pool 170 containing dozens to hundreds of active CIMs, all with varying amount of CIM Units available and varying External and Internal Factors in place, and would foreseeably receive thousands to tens of thousands of Selections, possibly with varying User Preferences, to compile into a single EV Batch 134 (with an aggregate EV surpassing the available CIM Units of any single CIM), it is evident that achieving an optimal allocation of CIM Units while satisfying all CARs 162 and, optionally, user preference rules within a reasonable time frame requires considerable computing power.

Since CIM Suppliers are also active in other markets and supply their Carbon Credits to multiple buyers (including large clients making sizeable purchases at once), some of which transactions may be automated, the availability of CCs to be converted into CIM Units in the CIM Pool may vary considerably from time to time even at a short notice. Therefore, to avoid invalid allocations due to supply shortages or similar variable reasons, it is desirable for the CME Transaction to be completed as quickly as possible.

Once the Penalty Functions 642 have been run and an (ObV-adjusted) OV Batch 644 has been prepared, the Carbon Market Engine 130 allocates variable amounts of CIM Units from the CIMs that it has selected for the given CME Transaction, per the (ObV-adjusted) OV Batch to match the EV Batch. As a result, Tentative Batch 1 646 is formed. At this stage, the CME may yet review TB1 against previous comparable CME Transactions to ascertain whether the current batch is in line with the statistical average quality of transactions at step 545. If yes, the engine accepts the batch for further processing at block 550. If not, it may re-run the previous steps at step 552 and allow some more time for the processing. The aim of the re-run is to increase the (ObV-adjusted) average OV/price of the batch to keep the overall quality of CME Transactions at a desirable level. After the re-run, a Tentative Batch 2 648 is returned and the CME chooses the batch with the higher (ObV-adjusted) OV/price as the Final Batch 650 for further processing.

Returning to method 200, once the CIM records are selected for the batch, they may be allocated to the requesting entities based on the emissions values and user preferences associated with each request at step 240. Once the Final Batch 650 is prepared, the CME 130 converts the CIM records allocated to it computationally into Meta Carbon Credits (and/or fractions thereof) 142 to satisfy the User Orders in the CME Transaction and, therefore, to Offset the Items in the included User Orders and/or to create MCCs (and/or fractions thereof) as requested in the included User Orders.

Note that the conversion from CIM Units into Meta Carbon Credits (and/or fractions thereof) is done in observance of the applicable CIM Units' OV, for example: CIM.1 . . . (OV=902): 516 CIM Units*0.902=0.465 MCC. The purpose of basing the conversion on the CIM Units' OV (rather than their face value) is to ensure that the climate benefit of each MCC thus created is true (1 MCC=1000 kg CO2e) and that each credit conforms to the quality standards set by the Platform operator. With this, the invention is geared toward remedying the systemic failures of the voluntary carbon market where one Carbon Credit often is not, in reality, equal to one metric ton of CO2 removed or sequestered from the atmosphere or said gases prevented from being emitted into the atmosphere.

The Carbon Market Engine 130 may also report to the User(s) about the sources and amounts of CIM Units allocated and the MCCs (and/or fractions thereof) issued and assigned to the User Order(s) via reporting module 144. Responses may then be transmitted to each received request of the plurality of requests, the responses each including a message for display on a graphic interface describing the allocated selected records for the requesting entity associated with the request at step 250 of method 200. The engine 130 may provide the User(s) with a certificate of issuance and assignment of the MCCs (and/or fractions thereof) to attest to the Offsetting of the corresponding EV, of other climate action or of another purchase of MCCs (and/or fractions thereof). The MCE may also record the unique identifiers of the MCCs (and/or fractions thereof) so issued and assigned so that every User, to whom such issuance and assignment is made, can refer to the unique MCCs (and/or fractions thereof) for example to present Offsetting claims or for compliance purposes.

To officially record the Offsetting in the carbon market, the engine may also report CME Transactions to Platform operator and the CIM Supplier(s) who, once all CIM Units from a given Carbon Credit have been allocated, register the retirement of the full Carbon Credit in the appropriate carbon market registry. Once the retirement is registered, the climate effect that the Carbon Credit in question represents is deemed to have been realized in the carbon market.

Later on, when further reporting data is available from the CIMs with regard to the CME Transaction, this data may also be passed on to the Carbon Market Engine to allow it to record the success of each transaction for statistical purposes and for improving its own operation. Using this feedback data 660, the engine may learn from mistakes made in evaluating the CIMs and make adjustments to the way it reads and applies the External Factors and Internal Factors entered in the CIM Pool.

As discussed above, the Platform offers a mechanism to specify User Preferences for the Offsetting, such as preferred CIM types, methods and geographical locations. An example of a preference would be favoring nature-based methods, including methods like reforestation, forest protection and kelp farming, using mechanical carbon capture. The Platform also might offer sets of CIMs as portfolios and offer User Preferences to favor certain CIMs over the others. Example portfolios might include innovative capture projects or community-run projects. User Preferences may be included in the Purchase Order, or be stored as part of User's general preferences. In addition, the Platform can have various global requirements installed as CIM allocation Rules (CARs)—such as maximum price per tCO2e or geographical regions—for CIM Unit allocations. The CARs are set by internal experts for the purposes of realizing certain overarching policy goals, of risk management, of inventory management or other similar reasons. These inputs are ultimately received by the Carbon Market Engine, which can then utilize artificial intelligence to allocate CIM Units in such a way that the weighted average Objective Value (ObV) of a CME Transaction will be maximized while respecting the CARs and, inasmuch as feasible, taking any User Preferences into account (which have been aggregated into user preference rules for the batch). The artificial intelligence method used may be a heuristic optimization algorithm such as Hill Climbing, Gradient Descent and/or some other suitable optimization algorithm.

The Platform contains data on a number of Climate Impacting Measures (CIM) that represent carbon sequestration projects operated by independent CIM Suppliers all over the world. With each CIM are associated a number of External and Internal Factors describing that particular instance. External Factors are received by the Platform from the CIM Suppliers, and they may include but are not limited to:
Price per CIM Unit
CIM method, e.g. reforestation or mechanical capture
Geographical location
Minimum CIM Unit purchase limit per transaction
Maximum CIM Unit purchase limit per transaction.

Internal Factors are received by the Platform from internal experts, and they may include but are not limited to:
Offset Value (OV)
Risk factors
Social/community impact
Impact on biodiversity.
   Some of the External and Internal Factors may be defined and assigned by the Platform's internal experts using their expertise and scientific knowledge. This process may be performed or assisted with computer methods including artificial intelligence and/or machine learning.

The Platform may include a mechanism for updating information about CIMs. The mechanism can include but not be limited to:
Software that runs on a computer which may be a handheld device and has access to the internet, e.g. a browser. A person representing a CIM Supplier operating a CIM issues updates via a user interface in the software.
Software that runs on a computer as part of Platform and has access to the internet and is capable of automatically issuing requests such as HTTP GET and POST requests. This software may have access to a computer service that acts as a marketplace to trade CCs from CIMs (Carbon Credit Exchange) and may be able to fetch information about up-to-date prices and availability of CCs to convert into CIM Units.

The Platform may also include a number of CIM allocation Rules (CARs) 162 that represent global requirements for making CIM Unit allocations. These rules ensure that in the absence or despite of User Preferences the goals of e.g. risk management and indirect benefits, such as increased biodiversity, are reached when processing a CME Transaction. Examples of applicable CARs may be but are not limited to:
CIM method: “CIM Units should be allocated from at least one CIM with method=“mechanical capture”
Region: “CIM Units should be allocated from CIMs on at least 2 different regions”
Maximum price: “The average price per tCO₂e over the whole CME Transaction should be less than x amount of money.”
Risk Factor: “The weighted average risk factor over the whole OV Batch should be less than y”
Impact Factors: “The weighted average Social & Biodiversity Impact Factor of the whole OV batch should be at least z”
   The CARs 162 may be defined and refined from time to time by the Platform's internal experts using their scientific expertise in accordance with the purchase policies and targets set forth by the operator.

To purchase MCCs (and/or fractions thereof) in order to Offset emissions or to engage in climate action, Users submit User Order arrays 605, 610, and 615 to the Platform. The mechanism for submitting a User Order array to the Platform may include but is not limited to:
Software that runs on a computer which may be a handheld device and has access to the internet, e.g. a browser. A person representing the User creates a User Order via a user interface in the software.
Software that runs on a computer and has access to the internet, and has capability to automatically create and submit User Orders via an interface defined by Compensate, for example using HTTP POST requests.

A User Order may be expressed as containing the decimal amount of a full Carbon Credit that the User wishes to purchase. The User Order also contains or is associated via the Platform with a price for the MCC amount in accordance with the price specified by the operator. In addition, the User Order array may contain User Preferences for the purchase such as:
CIM type: This refers to the general categorization of a CIM, for example avoidance (e.g. a cooking stove or a forest protection project) or removal (e.g. reforestation or mechanical capture project);
CIM method: may be a specific methodology or a more general categorization. An example of the general category is nature-based projects, which may include reforestation and forest protection; and
CIM region: this refers to a geographical area at the specificity set by the Platform operator (e.g. continent, sub-continent or country).

These User Preferences may also be stored under User's account in the Platform to be used as default preferences, which may be subsequently overridden by any User Order sent by the User to the platform.
Example:
User Order # n: vol=472 EV [amount of EV to Offset or MCC to purchase]; price=$ 28.00 [price per MCC to purchase]; type=“removal”; region=“Asia-Pacific”

The Platform includes a Carbon Market Engine (CME) 130 equipped with processing logic to receive User Orders from the Emission Calculations Engine and to transform them into an EV Batch 134, to select and allocate CIM Units from the CIM Pool 170 within received constraints, to compile an OV Batch 140 to match the EV Batch 134 and to issue and assign a corresponding amount of MCCs (and/or fractions thereof) 142 to realize the Offsetting, other climate action or the creation of MCCs for another purchase as requested in the User Orders included in the applicable CME Transaction.

The CME may store the User Orders until payment is successfully processed and transferred to the operator's account. The engine, employing processing logic within received rules, determines when there is a sufficient amount of User Orders to process the next CME Transaction. A CME Transaction may be triggered after a specified amount time has elapsed since last transaction, when there is a predetermined amount of funds allocated among relevant User Orders, manually by a human operator, or a combination thereof.

The CME 130 also stores information about CIMs and CIM Allocation Rules and offers a method for creating, updating and deleting them. The CME may also store User data concerning User's preferences for making MCC purchases. When the CME determines that a new purchase should be made, it further processes the information about User Orders, User purchase preferences, CIMs and CARs utilizing optimization logic.

In the next step, the Carbon Market Engine (CME) 130 utilizes optimization logic 136, employing artificial intelligence, to select a set of CIM Units that will maximize the Objective Value of the OV Batch and thereby return an optimal array of CIM Units as OV Batch to satisfy a corresponding EV Batch. For this purpose, the CME comprises a Control Module 132, CIM Module 670, Ranking and Optimization Module 136, and Acceptance Module 138.

The Control Module 132 controls the Ranking and Optimization Module 136 by preparing the EV Batch 134 and providing the Ranking and Optimization Module 136 a list of CIMs, along with their External and Internal Factors as well as the applicable CIM allocation Rules 162. Control Module 132 also directs the operation of the Ranking and Optimization Module 136 by issuing Optimization Run Rules (e.g. to determine how long the ROM is allowed to run), and providing storage. The purpose of the constraints set by the Control Module 132 is to balancing the number of optimization runs conducted by the Ranking and Optimization Module 136 and the Acceptance Module 138 against limitations of time and resources.

The CIM Module 670 provides all the necessary CIM properties that the Ranking and Optimization Module 136 needs in order to compute a set of CIM Units to allocate from a given set of CIMs.

The Ranking and Optimization Module 136 compiles the (tentative) OV Batches on the basis of data received from the foregoing modules and processes. Once a batch is ready, the module also runs Penalty Functions 642 to test the adherence of the batch to received rules and preferences (typically CIM Allocation Rules and User Preference rules (if available) but possibly also other rules and constraints). Where the batch does not conform to the rules and preferences, penalty factors received within the Penalty Functions 642 will be applied. The penalty factors will be applied to the Offset Value of the OV Batch during a single or multiple optimization runs (as may be set in the Optimization Run Rules). As a result, an Objective Value (ObV) is returned, which comprises the aggregate OV of the OV Batch readjusted by the Penalty Functions. The Ranking and Optimization Module 136 may then replace the aggregate OV of the batch with the value of the ObV, which typically reduces the aggregate OV of the batch and therefore makes it less optimal.

Example: in a simplified scenario, the CME Transaction includes only one User Order and there are three applicable CIMs. The User Order is for the Offsetting of an Item with EV=500. The CIM Pool data for the CIMs are as follows:
CIM1: type=“removal”; method=“reforestation”; region=“Asia-Pacific”; price=$10; OV=860 (For details on how the OV of a CIM is determined, see the definition of “Offset Value (OV)” above.)
CIM2: type=“removal”; method=“mechanical capture”; region=“Europe”; price=$28; OV=950
CIM3: type=“removal”; method=“mechanical capture”; region=“North America”; $29; OV=1100
   While it seems at first that allocating only CIM Units from CIM1 to this transaction would be the most cost-efficient option (OV Batch=860 OV; hence 581 CIM Units*$0.01=$5.81), the CME now applies Penalty Functions applicable to the CME Transaction, which consist of CIM Allocation Rules (CARs) and corresponding Penalty Factors P(CARn) as follows:
CAR1: Every CME Transaction must consist of CIMs from at least two regions: P(CAR1)=−0.40; and
CAR2: Every CME Transaction must allocate at least 5% of the CIM Units from method=“mechanical capture”: P(CAR2)=−0.70 (for affected portion).
   Therefore, allocating CIM Units only from CIM1 would incur both penalties, the result of which may be for example as follows:
OV(CIM Unit(CIM1))=860/1000=0.86
OV Batch=CIM1(500/0.86)=581 CIM Units
P(CAR1)=OV*−0.40=860*−0.40=−344 OV
P(CAR2)=(5%*OV)*P(CAR2)=43*−0.7=−30 OV
ObV=OV(CIM1)−P1−P2=860−344−30=486
ObV(CIM Units)=486/1000=0.486
ObV/price=486/$10=48.60
OV Batch=CIM1(500/0.486)=1029 CIM Units
price=CIM1(1029 CIM Units*$0.01)=$10.29
   As a result of the penalties, allocating CIM Units only from CIM1 is no longer optimal. Instead, a higher ObV/monetary unit could be reached for example as follows:
OV(CIM Unit(CIM1))=860/1000=0.86
OV(CIM Unit(CIM3))=1100/1000=1.10
OV Batch=CIM1(500*95%/0.86)+(500*5%/1.10)=552+23=575 CIM Units
ObV=OV(CIM1)*95%+OV(CIM3)*5%=817+55=872
ObV/price=817/$10+55/$29=81.70+1.90=83.60
price=CIM1(552 CIM Units*$0.01)+CIM3(23 CIM Units*$0.029)=$5.52+$ 0.67=$6.19
   A more thorough example of a complete CME Transaction is described below, in the accompanying text to FIG. 7. The selection process may be performed by an algorithm such as Hill Climbing, Gradient Descent and/or some other suitable optimization algorithm. There are two ways to train the model used for the selection process: with synthetic data, and/or with enriched data. Synthetic data may be generated programmatically to serve as EV as well as User Preferences. Enriched data may use expertise and historical data, such as the EVs and user preferences of historic user CIM requests.

The Penalty Functions 642 provide penalty factors to be applied to the ObV based on how well the OV Batch 140 satisfies the rules, preferences and other constraints as defined for each Penalty Function instance. The aggregate ObV of the batch is readjusted by penalty factors (for example by negative decimal multiplication) to arrive at the final ObV for the OV Batch. Using penalty factors (instead of hard and fast constraints) ensures on the one hand that the Ranking and Optimization Module will favor solutions that fulfill the CARs and User Preferences received within the Penalty Functions, but on the other hand allows for flexibility so that a solution will always be found in case it is not possible to satisfy all such constraints.

Note that in case no feasible solution is found within set parameters, the Ranking and Optimization Module 136 could ultimately decide to forgo for example a number of CARs with the lowest penalty factors. While this would still reduce the ObV-adjusted OV of the batch, the effect of the applicable Penalty Functions would be much more limited than in the above example. In other words the module 136 could, as an alternative to recompiling the OV Batch, decide to keep the original composition even though it would not adhere to all CARs and the ObV-adjusted OV would be reduced. This could be the case for example when the effect of the applicable Penalty Functions would be so small that keeping the original composition and suffering the penalties would still be reasonably efficient (or even more efficient) than an alternative composition. In such case, the module could, instead of abandoning the original batch, add more CIM Units to it until the aggregate OV would be equal to the EV Batch. Such decision could also be made subject to certain constraints such as an acceptable level under which an original composition could be kept (e.g. combined penalty of −0.10 or less). Such constraints could depend on received limits but could also be conceivably recalibrated by the Meta-Optimization Logic of the CME 130.

In accordance with the foregoing, the Ranking and Optimization Module 136 selects a set of CIM Units from applicable CIMs in such a way that the effect (ObV-adjusted) aggregate OV of the OV Batch is maximized, under the constraint that the amount of available funds (as allocated by the User Orders in the CME Transaction) must not be exceeded. This formulation means that the problem is one of constrained optimization, which means that any algorithms for solving such problems can be utilized. Since the optimization process is nonlinear, due to Penalty Functions being allowed to take any form, algorithms that rely only on repeatedly (re-)evaluating the ObV may be employed. Such algorithms include, but are not limited to:
Hill Climbing
Gradient Descent
Particle Swarm Optimization
Simulated Annealing.
   Any variant of enhancement of the above, or any other suitable, algorithms, such as employing genetic algorithms to run several optimization runs in parallel can be employed to increase the effectiveness and/or runtime of the Ranking and Optimization Module.

Using any of these methods, the Ranking and Optimization Module 136 will arrive at an OV Batch 140 that will at least provide local maxima for the module from a given starting point, which may be an empty portfolio. During the execution the module receives information about CIMs and their External and Internal Factors, for example the minimum and maximum allowed amount of CIM Units to allocate and the price of each CIM Unit. In addition, it applies the Penalty Functions a number of times (per the Optimization Run Rules) to determine the set of CIM Units that will minimize the effect of the Penalty Functions and will therefore return a maximal ObV. Once the module arrives at the optimal solution, it returns an array of CIM Units as the (ObV-adjusted) OV Batch that will satisfy the corresponding EV Batch in the relevant CME Transaction (Tentative Batch 1). The OV Batch is therefore adjusted to match the Objective Value. The Ranking and Optimization Module 136 will then pass the tentative batch 646 so derived on to the Acceptance Module 138.

Finally, the Acceptance Module 138 tests the Tentative Batch (TB1) 646 returned by the Ranking and Optimization Module 136 to see if the aggregate ObV of the batch is in line with historical averages of previous CME Transactions (if available). If so, the Acceptance Module 138 accepts TB1 646 and passes it on as the Final Batch 650 to satisfy the corresponding EV Batch and to conclude the CME Transaction. If not, the Acceptance Module 138 returns TB1 646 to the Ranking and Optimization Module 136 for additional optimization runs, the number of such additional runs as set in the Optimization Run Rules. In such case the Ranking and Optimization Module 136 will create a new (tentative) OV Batch (TB2) 648 and re-submit it to the Acceptance Module 138. The Acceptance Module 138 will accept the most optimal of the two (tentative) OV Batches returned by the Ranking and Optimization Module 136 and pass it on as the Final Batch 650. At the conclusion of the CME Transaction, the CME may issue a notification to the User, the Platform operator, CIM Supplier and/or another party about the successfulness of the CME Transaction via reporting module 144.

Since the operation of any of the optimization methods above is not tractable for a human with any reasonably sized input (due to the number of CIMs/CCs, amounts of available funds, given set of rules and preferences and so on), using fixed parameters for a given method may not ensure that a good local optimum is found with given time limitations. Accordingly, as described above, the trained model used by the CME may be given given “soft” rules in the form of Penalty Functions that at least in theory allow the CME to make nominally “sub-optimal” decisions, but make them less attractive for it by penalizing choices using the penalty functions that do not conform to the soft rules. As a result, the trained model is allowed to explore solutions within flexible yet reasonable boundaries, allowing the trained model to identify a solution within the desired time limits, even if the solution is not strictly in compliance within the set rules delineated by the CARs.

In order to increase the optimal performance of the Optimization Logic described above, a method for using machine learning to modify the parameters of optimization logic is described herein. In addition to direct historical CME Transaction data saved by the Platform, peripheral information regarding CIM data, CIM Allocation Rules, User Orders etc. applicable to each such CME Transaction, as well as post-CME Transaction data (e.g. reports of certain CIMs failing at later time) may be stored for use by the Meta-Optimization Logic. With this data it is possible to recreate any previous CME Transaction at a later time and also to take into account relevant post-transaction data (in hindsight).

The method may be performed by a driver program that may:
read historical purchase data and other data (such as CIM supply data);
use a machine-learning algorithm to alter the parameters of the optimization logic; and
evaluate the optimization logic with a given set of parameters over historical purchases.
   The goal of the Meta-Optimization Logic driver program is to run the machine-learning algorithm over a set of historical CME Transactions (the training set)—while adjusting optimization logic parameters (such as Internal Factors and Penalty Functions)—to arrive at a set of parameters that provide improvements to the Ranking and Optimization Module. The aim of such improvements is to evaluate how well the optimization logic performed in earlier CME Transactions, and to simulate a number of such earlier transactions on the basis of the adjusted parameters (the validation set). If an adjusted set of parameters is found to be superior to the original parameters, the CME may take these into use in future CME Transactions to increase the likelihood of maximizing the aggregate ObV of OV Batches over time.

A practical example of this would be as follows: The Meta-Optimization Logic module recognizes that a great number of CME Transactions have been subject to heavy penalties under certain Penalty Functions as almost no available combination of CIM Units has met all Internal Factors received. As a result, the module may decrease the weight of penalties flowing from a breach of certain Internal Factors that may be virtually impossible to meet. Conversely, the module may increase the weight of such penalties if it recognizes e.g. that CIMs scoring high on certain Internal Factors tend to succeed more often post-CME Transaction (i.e. the failure rate of CIMs meeting such Internal Factors is on the average much lower over time). The possibilities of employing recreated CME Transaction data and peripheral data (including post-transaction) data are broad and variable and cannot be described here in detail.

As the Meta-Optimization Logic algorithm is an instance of hyperparameter optimization, any algorithm used for that purpose, such as Bayesian optimization, may be employed. As an example, if simulated annealing was used as the algorithm for purchase optimization, the parameters to be optimized would be:
Starting temperature
Annealing schedule
Number of time steps
Any parameters used by the acceptance probability function.
   In addition, if e.g. random restarts would be employed, the number of rounds could be added to the set of parameters. This type of meta-optimization may be employed by the Acceptance Module 138 as described above.

FIG. 7 shows a flow diagram of a specific embodiment of a method 700 of selecting and allocating CIM records using a carbon market engine. The example method 700 is based on user order/CIM request 702 being for 200 EVs, user order 704 being for 50 EVs, and user order 706 being for 250 EVs. User order 702 may further include user preferences for the Asia-Pacific region (in a region field), and an 80% preference for reforestation in the type field of the order. User order 704 may include only a region preference for the Africa region, while user order 706 may include a 50% type-preference for reforestation, and a 50% type-preference for technology. As shown, the user preferences may include allocations in any desired type specified by the user. In this simplified sample process, the Ranking and Optimization Module (ROM) 136 only conducts a limited number of runs to compile an OV Batch. In reality, the ROM 136 may conduct numerous runs within received Optimization Run Rules to determine which combination of CIM Units would return the optimal OV Batch. Examples of commands used by the ROM 136 below are for illustrative purposes only and intend to make no connection with any programming language.

The ROM 136 may qualify a number of CIMs from the CIM Pool 752 as candidates for the Tentative Batch 747 as shown in Table 1. In the charts below, only a limited number of columns are shown for illustrative purposes. These are depicted to illustrate the raw data on which the ROM bases its calculations in this sample process. The received EV batch, including an aggregated emissions value, may be defined as:

### EV Batch=500 EV; OV Batch=500 OV; 1 CIM Unit=1/1000 CC

The cumulative EV batch value may be obtained from three received CIM requests 702, 704, and 706. The ECE may provide information 715 including the CIM requests, the associate EVs for the request, and the user preferences for each request, which may be aggregated for the batch as user preference rules 710. Each user preference in the user preference rules 710 may be associated with the EV value for the individual user order from which the user preference originated. For example, the user preference rules for user order 706 within the user preference rules data structure 701 may be expressed as:
UP4: prefer 125 EV from method=“reforestation”
UP5: prefer 125 EV from method=“technology.”

The CIM allocation rules (CARs) 722 and their affiliated penalties 724 may be retrieved from the CIM module 720 by the control module 132. The CARs may be individually defined as follows:
CAR1 733: since the CAR requires allocating at least 75% of aggregate OV from CIM type=“reforestation,” 375 OV out of the 500 OV total for the batch may be required to be of “reforestation” type;
P(CAR1): penalty=−0.10;
CAR 2 735: the CAR may require allocation from at least 2 different regions (max 90% each); accordingly at least 50 OV may be required to be allocated from different regions;
P(CAR2): penalty=−0.20;
CAR3 737: the CAR may require allocation of at most 5% of aggregate OV from CIMs with failure_risk>14, therefore no more than 35 OV of the batch may be allocated to CIMs having a failure risk parameter greater than 14;
P(CAR3): penalty=−0.70.
   Control module may utilize applied CARs 733, 735, and 737 to generate aggregate applied CAR and user preference schema 739. Aggregate schema 739 may organize the CARs and user preference rules from 710 to facilitate selection of the CIMs for the batch, and may be applied sequentially by the Ranking and Organization Module (ROM) 136. For example, the aggregate schema 739 may organize the rules in the following manner:
CAR.1: allocate 375 OV from type “reforestation;” [to be met first]
   UP1: prefer 200 OV from region “Asia-Pacific;”
   UP2: prefer 50 EV from region “Africa.”
CAR.2: allocate ≥50 OV from at least two regions; [to be met second]
UP3: if OV (region “Asia-Pacific”)<200, prefer 200 OV−OV (region “Asia-Pacific”) from region “Asia-Pacific;”
UP4: if OV (region “Africa”)<50, prefer 50 OV−OV (region “Africa”) from region “Africa;”
CAR.3: allocate ≤25 OV from failure_risk>14;
UP5: if OV (method “technology”)<125, prefer 125 OV−OV (method “technology”) from method “technology.”
   The aggregate schema 739 may be passed from control module 132 to the ROM 136 for use in the CIM selection in some embodiments.

ROM 136 may use CIM evaluation rules to identify potential CIM records to offset the identified items in the batch at block 745, resulting in tentative batch 747. CIM records may be selected from CIM database 752, which is displayed in Table 1, and received by ROM 136 from CIM module 750. Optimization rules 741 may be received from the control module 132 to manage the use of the trained model by ROM 136 to select CIMs. Exemplary optimization rules may include a “Maximum time per pass” parameter being set to a predetermined value (e.g., 1000 ms, or any desired value), and/or “maximum passes per step” parameter being set to a predetermined value (e.g., 2 passes, or any desired value).

TABLE 1
CIMs selected from CIM Pool for TB1.

| | | | | | | | | | ov/ | inventory |
|---|---|---|---|---|---|---|---|---|---|---|
| CIM | type | method | region | ov | climate_integrity | community_impact | failure_risk | price | price | (CIM Units) |
| CIM.1.a.i | removal | reforestation | Asia-Pacific | 860 | 84 | 89 | 10 | $20.00 | 43.00 | 1250 |
| CIM.1.a.ii | removal | reforestation | Asia-Pacific | 875 | 85 | 92 | 12 | $20.50 | 42.68 | 226 |
| CIM.1.a.iii | removal | reforestation | Asia-Pacific | 1050 | 95 | 78 | 15 | $22.00 | 47.73 | 155 |
| CIM.1.a.iv | removal | reforestation | Asia-Pacific | 901 | 75 | 77 | 14 | $20.00 | 45.05 | 4865 |
| CIM.1.b.i | removal | soil_carbon | Asia-Pacific | 960 | 88 | 89 | 11 | $21.00 | 45.71 | 4886 |
| CIM.1.b.ii | removal | soil_carbon | Asia-Pacific | 972 | 89 | 73 | 9 | $20.00 | 48.60 | 5562 |
| CIM.1.b.iii | removal | soil_carbon | Asia-Pacific | 1005 | 92 | 67 | 10 | $24.00 | 41.88 | 126 |
| CIM.1.c.i | avoidance | technology | Asia-Pacific | 600 | 65 | 90 | 20 | $38.00 | 15.79 | 4884 |
| CIM.2.a.i | avoidance | farming | Africa | 720 | 75 | 96 | 14 | $24.00 | 30.00 | 987 |
| CIM.2.b.i | removal | soil_carbon | Africa | 950 | 91 | 89 | 16 | $14.00 | 67.86 | 3665 |
| CIM.3.a.i | removal | technology | North America | 1200 | 98 | 86 | 5 | $28.00 | 42.86 | 10 |

To satisfy CAR1, the ROM 136 may split the OV Batch up into two Tentative Sub-Batches (TSB1.1 and TSB1.2):
In TSB1.1 (target_vol(1)=375 OV), it qualifies CIMs from type=“reforestation”;
In TSB1.2 (target_vol(2)=125 OV), it qualifies all CIMs.

CAR1. allocate min 75% from type=“reforestation”; P(CAR1) penalty=−−0.10;

TSB1.1(1): target_vol=375.00 from type=”reforestation”;

TABLE 2
CIMs selected for TSB1.1(1).

| | | | | | | | | | ov/ | inventory |
|---|---|---|---|---|---|---|---|---|---|---|
| CIM | type | method | region | ov | climate_integrity | community_impact | failure_risk | price | price | (CIM Units) |
| Start state | | | | | | | | | | |
| CIM.1.a.i | removal | reforestation | Asia-Pacific | 860 | 84 | 89 | 10 | $20.00 | 43.00 | 1250 |
| CIM.1.a.ii | removal | reforestation | Asia-Pacific | 875 | 85 | 92 | 12 | $20.50 | 42.68 | 226 |
| CIM.1.a.iii | removal | reforestation | Asia-Pacific | 1050 | 95 | 78 | 15 | $22.00 | 47.73 | 155 |
| CIM.1.a.iv | removal | reforestation | Asia-Pacific | 901 | 75 | 77 | 14 | $20.00 | 45.05 | 4865 |

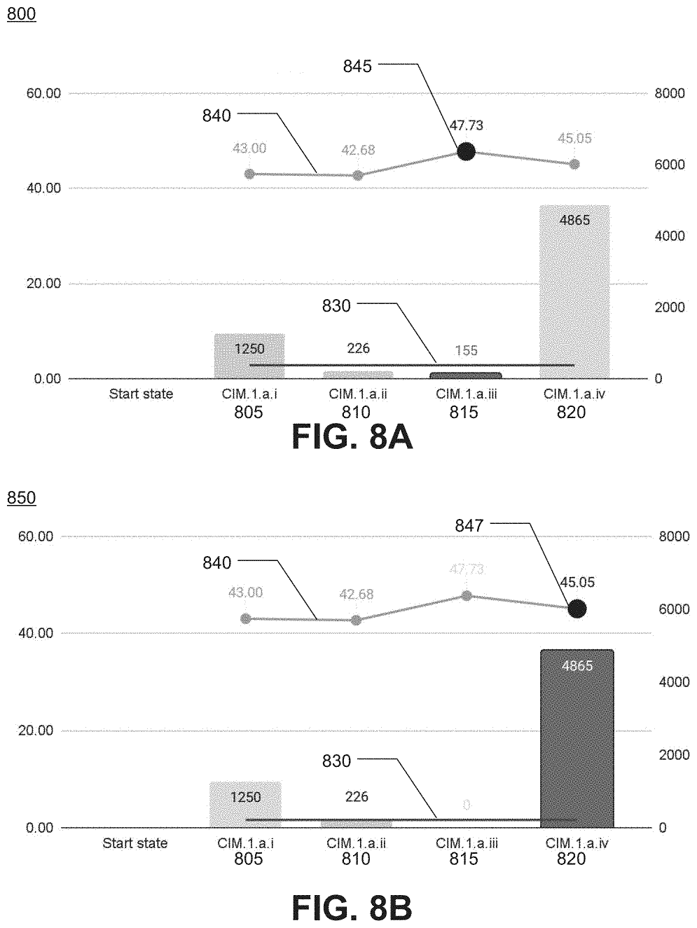

FIG. 8A shows the results 800 of a first run, corresponding to tentative sub-batch TSB1 0.1 shown in Table 2, of the trained model for selecting CIMs, according to an embodiment. Four CIM records are shown: CIM.1.a.i 805, CIM.1.a.ii 810, CIM.1.a.iii 815, and CIM.1.a.iv 820, along with amounts of each CIM available. The needed amount is indicated by line 830, while curve 840 indicates the OV per unit cost for each CIM. The ROM 136 finds that CIM.1.a.iii 815 has the highest OV/price (as seen in Table 2), and selects it for the TSB1.1. However, CIM.1.a.iii's inventory is only 155 units, less than the 375 required for the sub-batch. The ROM 136 may allocate maximum available inventory 155 CIM Units*1.05 OV=162.75 OV from CIM.1.a.iii 815 for TSB1.1 run 1. The ROM 136 has failed to meet target_vol by 375 OV-162.75 OV=212.25 OV.

The ROM 136 may then conduct a second run for TSB1.1 with target_vol=212.25 OV with the same conditions under CAR1.

TSB1.1(2): target_vol=212.25;
FIG. 8B shows the results 850 of the second run of the trained model for selecting CIMs, according to an embodiment. The ROM 136 finds that CIM.1.a.iv 820 has the next highest OV/price, and selects it for the TSB1.1 run 2. The ROM 136 allocates 236 CIM Units*0.901=212.40 OV from CIM.1.a.iv 820. The ROM has now allocated the required 375 OV (rounded down) from two qualifying CIMs with the highest average OV/price. The engine marks CAR1 as completed.

TSB1.1: cim_units(CIM.1.aiv)=155; cim_units(CIM.1.a.iii)=236, vol=375,

CAR1: success=“true”;

Next, the ROM 136 processes sub-batch TSB1.2 with target_vol=125 OV. It notes that CAR2 and CAR3 are still incomplete. To satisfy CAR2, the ROM 136 favors CIMs from regions not in TSB1.1. However, to maximize OV/price of the batch, it limits the selection only to the minimum volume required by CAR2 (min 10/from a region that is not “Asia-Pacific”). To satisfy CAR1, the ROM 136 splits TSB1.2 into further sub-batches (TSB1.2.1 and TSB1.2.2):
a. In TSB1.2.1 (target_vol=100 OV), it qualifies CIMs from region!=“Asia-Pacific”;
b. In TSB1.2.2 (target_vol=25 OV), it qualifies all CIMs.

CAR 2: allocate from min 2 regions (max 90% each); P(CAR2): penalty=−0.20;

TSB1.2.1. target_vol=100ov from region!=”Asia-Pacific”

TABLE 3
CIMs selected for TSB1.2.1.

| | | | | | | | | | ov/ | inventory |
|---|---|---|---|---|---|---|---|---|---|---|
| CIM | type | method | region | ov | climate_integrity | community_impact | failure_risk | price | price | (CIM Units) |
| Start state | | | | | | | | | | |
| CIM.2.a.i | avoidance | farming | Africa | 720 | 75 | 96 | 14 | $24.00 | 30.00 | 987 |
| CIM.2.b.i | removal | soil_carbon | Africa | 950 | 91 | 89 | 16 | $14.00 | 67.86 | 3665 |
| CIM.3.a.i | removal | technology | North America | 1200 | 98 | 86 | 5 | $28.00 | 42.86 | 10 |

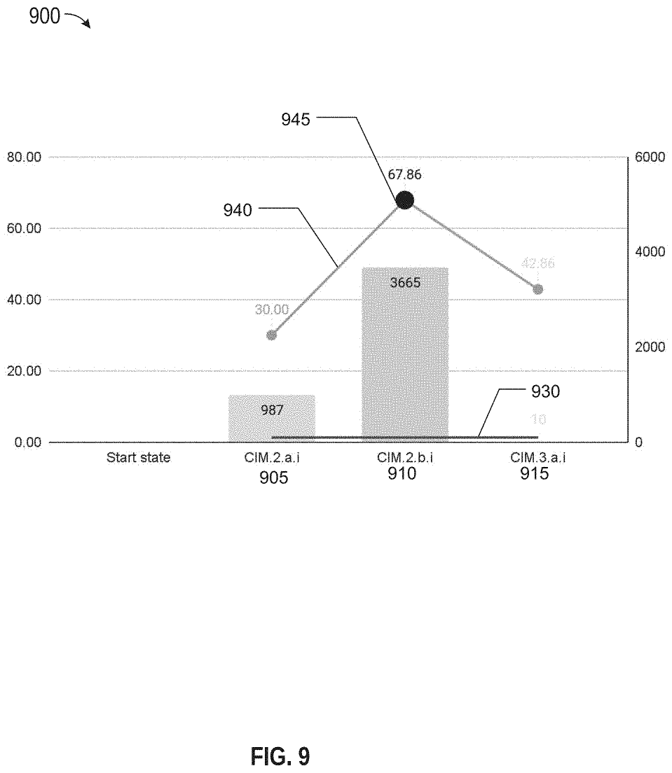

FIG. 9 shows the results 900 of another run of the trained model for selecting CIMs for TSB 1.2.1 (described in Table 3), according to an embodiment. Three CIM records are shown: CIM.2.a.i 905, CIM.2.b.i 910, and CIM.3.a.i 915, along with amounts of each CIM available. The needed amount is indicated by line 930, while curve 940 indicates the OV per unit cost for each CIM. According to the results 900, the ROM 136 finds that CIM.2.b.i 910 has the highest OV/price 945, and selects it for the TSB1.2.1. The ROM 136 allocates 106 CIM Units*0.95 OV=100 OV (rounded down) from CIM.2.b.i 910. The ROM has now allocated the required 100 OV from region!=“Asia-Pacific” with the highest average OV/price, which completes sub-batch 1.2.1. The engine marks CAR2 as completed.

TSB1.2; cim_units(CIM.2.b.i)=105264; vol=100;

CAR2: success=“true”;

Next, the ROM 136 processes sub-batch TSB1.2.2 with target_vol=25 OV. It notes that CAR3 is still incomplete.

CAR3: allocate max 5% from failure_risk>14; P(CAR3): penalty=−0.70;

TSB1.2.2: target_vol=25ov from failure_risk=<14;

TABLE 4
CIMs selected for TSB1.2.2.

| | | | | | | | | | ov/ | inventory |
|---|---|---|---|---|---|---|---|---|---|---|
| CIM | type | method | region | ov | climate_integrity | community_impact | failure_risk | price | price | (CIM Units) |
| CIM.1.a.i | removal | reforestation | Asia-Pacific | 860 | 84 | 89 | 10 | $20.00 | 43.00 | 1250 |
| CIM.1.a.ii | removal | reforestation | Asia-Pacific | 875 | 85 | 92 | 12 | $20.50 | 42.68 | 226 |
| CIM.1.a.iv | removal | reforestation | Asia-Pacific | 901 | 75 | 77 | 14 | $20.00 | 45.05 | 4865 |
| CIM.1.b.i | removal | soil_carbon | Asia-Pacific | 960 | 88 | 89 | 11 | $21.00 | 45.71 | 4886 |
| CIM.1.b.ii | removal | soil_carbon | Asia-Pacific | 972 | 89 | 73 | 9 | $20.00 | 48.60 | 5562 |
| CIM.1.b.iii | removal | soil_carbon | Asia-Pacific | 1005 | 92 | 67 | 10 | $24.00 | 41.88 | 126 |
| CIM.2.a.i | avoidance | farming | Africa | 720 | 75 | 96 | 14 | $24.00 | 30.00 | 987 |

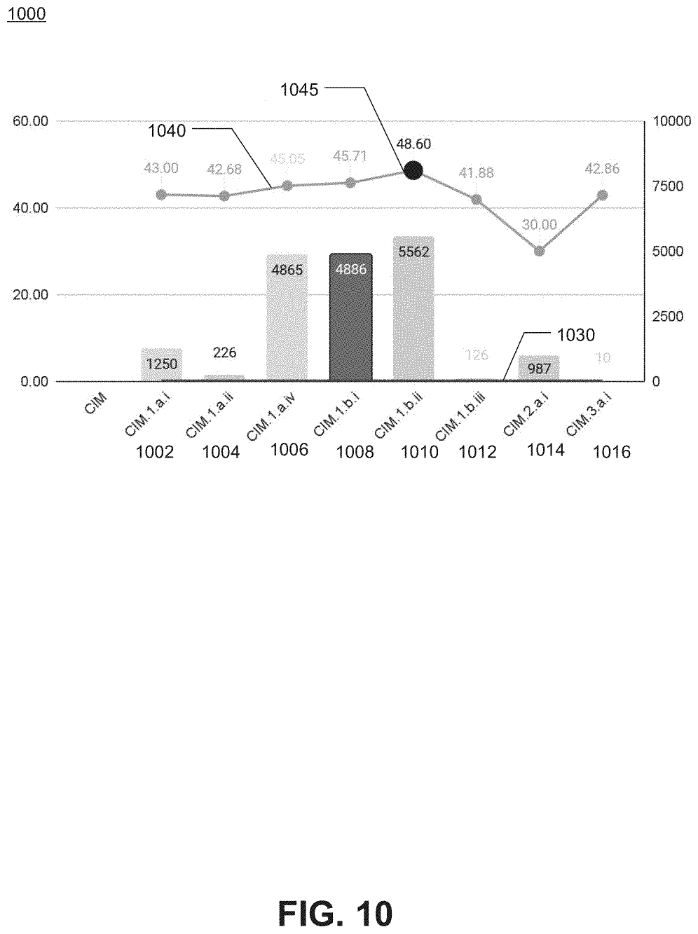

FIG. 10 shows the results 1000 of another run of the trained model for selecting CIMs for TSB 1.2.2 (described in Table 4), according to an embodiment. Eight CIM records are shown: CIM.1.a.i 1002, CIM.1.a.ii 1004, CIM.1.a.iv 1006, CIM.1.b.i 1008, CIM.1.b.ii 1010, CIM.1.b.iii 1012, CIM.2.a.i 1014, and CIM.3.a.i 1016, along with amounts of each CIM available. The needed amount is indicated by line 1030, while curve 1040 indicates the OV per unit cost for each CIM. The ROM 136 finds that CIM.1.b.ii 1010 has the highest OV/price 1045, and selects it for the TSB1.2.2. The ROM 136 allocates 26 CIM Units*0.972 OV=25 OV (rounded down) from CIM.1.b.ii 1010.

The ROM 136 has now allocated the final 25 OV from failure_risk=<14 with the highest average OV/price, which completes sub-batch 1.2.2. However, the engine cannot mark CAR3 as completed as the final allocation does not in itself ensure that a maximum of 5% of the OV in the batch comes from CIMs with failure_risk of 15 or higher.

TSB1.2.2: cim_units(CIM.1.b.ii)=25721; vol=25;

CAR3: success=“false”;

TB1 would then look like as shown in Table 5:

TABLE 5
Tentative OV Batch 1.

| | | | ov/ | allocated | aggregate | % aggregate | price/ | total |
|---|---|---|---|---|---|---|---|---|
| CIM | ov | failure_risk | price | (CIM Units) | ov | ov | CC | price |
| CIM.1.a.iii | 1050 | 15 | 47.73 | 155 | 162.75 | 32.55 | $22.00 | $3.41 |
| CIM.1.a.iv | 901 | 14 | 45.05 | 236 | 212.63 | 42.52 | $20.00 | $4.72 |
| CIM.1.b.ii | 972 | 9 | 48.60 | 26 | 25.27 | 5.05 | $20.00 | $0.52 |
| CIM.2.b.i | 950 | 16 | 67.86 | 106 | 100.70 | 20.14 | $14.00 | $1.48 |
| | | | | | 501.35 | 100.26 | | $10.13 |

The average OV/price of TB1 would be 500 OV/$10.13=49.36. To test the feasibility of the OV Batch against the CARs, the ROM applies Penalty Functions from P(CAR3).
CAR3: allocate max 5% from failure_risk>14; P(CAR3): penalty=−0.70;
The ROM 136 finds that only 47.57% of the OV in the batch comes from CIMs with a failure_risk of 14 or less whereas the target set by CAR3 is 95%.

The ROM 136 applies the penalty factor of −0.70 to the OV Batch in accordance with received principles. For illustrative purposes, the penalty factor is applied here to the portion of the OV Batch that does not adhere to CAR3 (500 OV−5%−47.57%=500 OV−25 OV−238 OV=237 OV). As a result, the Objective Value of the OV Batch is 500 OV−237 OV*0.70=334 ObV, thus the aggregate OV of the OV Batch is reduced to 334 OV. Due to the Penalty Functions and the resulting OV reduction, the ROM 136 decides to conduct additional runs to improve the aggregate OV of the Batch.

To do this, the ROM 136 may for example begin by looking for a replacement for the CIM with the lowest OV/price with failure_risk of 15 or higher in the batch. In this case, the CIM to be replaced would be CIM.1.a.iii. The ROM may do this for example by re-running CAR1, with the results being shown in Table 6.

TSB1.1(R): target_vol=375.00 from type=“reforestation” and failure_risk<=14;

TABLE 6
CIMs selected for TSB1.1(R).

| | | | | | | | | | ov/ | inventory |
|---|---|---|---|---|---|---|---|---|---|---|
| CIM | type | method | region | ov | climate_integrity | community_impact | failure_risk | price | price | (CIM Units) |
| Start state | | | | | | | | | | |
| CIM.1.a.i | removal | reforestation | Asia-Pacific | 860 | 84 | 89 | 10 | $20.00 | 43.00 | 1250 |
| CIM.1.a.ii | removal | reforestation | Asia-Pacific | 875 | 85 | 92 | 12 | $20.50 | 42.68 | 226 |
| CIM.1.a.iv | removal | reforestation | Asia-Pacific | 901 | 75 | 77 | 14 | $20.00 | 45.05 | 4865 |

Repeating the steps depicted above, the ROM finds that CIM.1.a.iv has the highest OV/price, and selects it for the TSB1.1(R). The ROM therefore removes the CIM Units from CIM.1.a.iii from the OV Batch and allocates a total of 417 CIM Units*0.901 OV/1000=375 OV from CIM.1.a.iv.

As the ROM 136 would find that even after the first re-run CAR3 would not yet be satisfied, it could attempt additional re-runs with all CARs to find an optimal combination of CIM Units to minimize the effect of the Penalty Functions. At the end, the OV Batch could look like as shown in Table 7:

TABLE 7
Recompiled TB1.

| | | | ov/ | allocated | aggregate | % | price/ | |
|---|---|---|---|---|---|---|---|---|
| CIM | ov | failure_risk | price | (CIM Units) | ov | aggregate ov | CC | total price |
| CIM.1.a.iv | 901 | 14 | 45.05 | 417 | 375.71 | 75.142 | $20.00 | $8.34 |
| CIM.1.b.ii | 972 | 9 | 48.60 | 26 | 25.27 | 5.054 | $20.00 | $0.52 |
| CIM.2.a.i | 720 | 14 | 30.00 | 88 | 63.36 | 12.672 | $24.00 | $2.11 |
| CIM.2.b.i | 950 | 16 | 67.86 | 26 | 24.70 | 4.94 | $14.00 | $0.36 |
| CIM.3.a.i | 1200 | 5 | 42.86 | 10 | 12.00 | 2.4 | $28.00 | $0.28 |
| | | | | | 501.04 | 100.21 | | $11.62 |

Although the average OV/price of the modified OV Batch would be 500 OV/$11.63=42.99, which is less than the OV/price of the original OV Batch (49.36), it is still more optimal than the ObV-adjusted OV/price of the original batch (334 OV/$10.13=$32.97). Therefore, with a reasonable reduction in the average OV/price of the batch the high quality (500 EV=500 OV) can be ensured by recompiling the batch so that it adheres to the applicable CARs.

The Acceptance Module (AM) 138 receives from the Ranking and Optimization Module 136 the Tentative Batch 1 747, which is displayed below in Table 8:

TABLE 8
TB1 received from the Ranking and Optimization Module.

| | | | ov/ | allocated | aggregate | % aggregate | price/ | total |
|---|---|---|---|---|---|---|---|---|
| CIM | ov | failure_risk | price | (CIM Units) | ov | ov | CC | price |
| CIM.1.a.iv | 901 | 14 | 45.05 | 417 | 375.71 | 75.142 | $20.00 | $8.34 |
| CIM.1.b.ii | 972 | 9 | 48.60 | 26 | 25.27 | 5.054 | $20.00 | $0.52 |
| CIM.2.a.i | 720 | 14 | 30.00 | 88 | 63.36 | 12.672 | $24.00 | $2.11 |
| CIM.2.b.i | 950 | 16 | 67.86 | 26 | 24.70 | 4.94 | $14.00 | $0.36 |
| CIM.3.a.i | 1200 | 5 | 42.86 | 10 | 12.00 | 2.4 | $28.00 | $0.28 |
| | | | | | 501.04 | 100.21 | | $11.62 |

To test the quality of TB1 747, the Acceptance Module 138 compares the average OV/price of the batch to previous CME Transactions with similar CIM Allocation Rules and User Preferences (if such transactions are available) at block 761. As shown in Table 9, the Acceptance Module 138 may also use other metrics for measuring the quality of TB1 747, such as expected average OV/price based on various meta data such as statistical average increase in quality over time.

TABLE 9
Average OV/price data for TB1 and previous CME Transactions

| OV Batch | avg OV/price |
|---|---|
| CME Transaction x | 42.30 |
| CME Transaction y | 44.35 |
| CME Transaction z | 45.54 |
| Tentative Batch 1 | 42.99 |

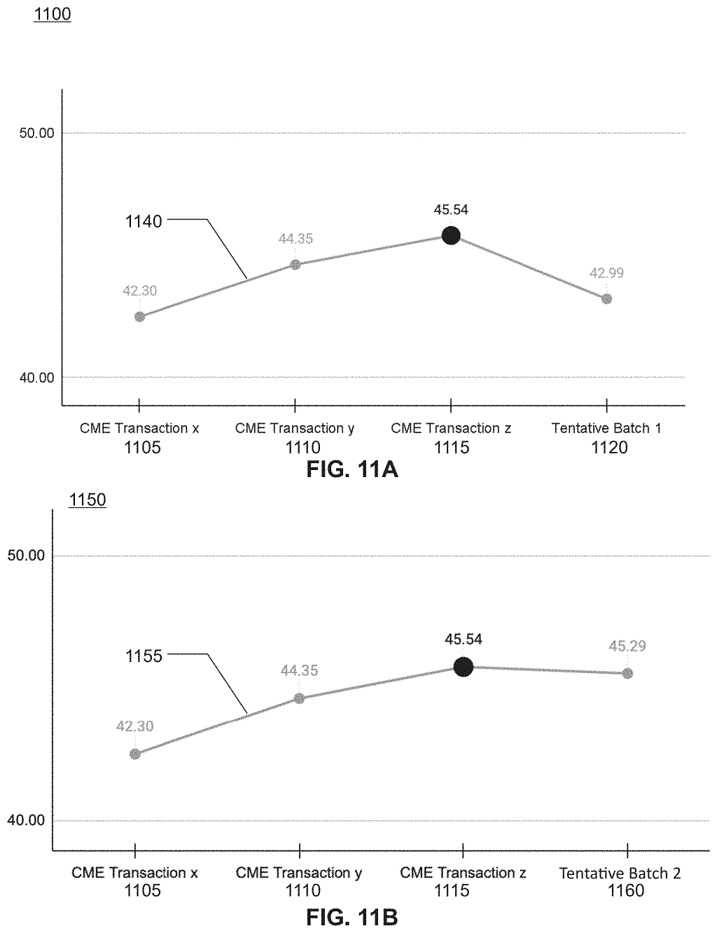

FIG. 11A shows a comparison 1100 of a scaled objective value of a set of selected CIM records with historical data to the scaled objective value of TB1 747, according to an embodiment. Three historical CME transactions are displayed, matching the data in Table 9: transaction x 1105, transaction y 1110, and transaction z 1115, along with the scaled objective value of TB1 1120. Curve 940 indicates the OV per unit cost for each transaction shown. In this case, the Acceptance Module 138 notes that the Tentative Batch 1 1120 falls short of the quality of the previous purchase (CME Transaction z 1115). The Acceptance Module 138 returns TB1 747 to the Ranking and Optimization Module 136 for additional Optimization Runs.

To try to improve the quality of TB1, the Acceptance module directs the Ranking and Optimization Module 136 to redo the run, with a longer runtime at block 763. The ROM 136 receives permission from the Control Module 132 to spend more time on finding a better solution if necessary. As a result, the ROM 136 finds that by reducing CIM Units from CIM 2.a.i (with a low ov/price of 30.00) from 88 to 19 and increasing CIM Units from CIM.1.a.iv (with higher ov/price of 45.05) from 417 to 471 the OV Batch would still adhere to all applicable CARs yet the average OV/price of the batch would be higher.

The ROM 136 therefore returns the Tentative Batch 2 illustrated in Table 10:

TABLE 11
Average OV/price data for TB2 and previous CME Transactions

| OV Batch | avg OV/price |
|---|---|
| CME Transaction x | 42.30 |
| CME Transaction y | 44.35 |
| CME Transaction z | 45.54 |
| Tentative Batch 2 | 45.29 |

Now, the average OV/price of the OV Batch would be 500 OV/$11.04=45.29. The AM 138 repeats the comparison of historical with TB2 as shown in Table 11.

TABLE 10
TB2 received from the Ranking and Optimization Module 136.

| | | | ov/ | allocated | aggregate | % | price/ | total |
|---|---|---|---|---|---|---|---|---|
| CIM | ov | failure_risk | price | (CIM Units) | ov | aggregate ov | CC | price |
| CIM.1.a.iv | 901 | 14 | 45.05 | 471 | 424.37 | 84.874 | $20.00 | $9.42 |
| CIM.1.b.ii | 972 | 9 | 48.60 | 26 | 25.27 | 5.054 | $20.00 | $0.52 |
| CIM.2.a.i | 720 | 14 | 30.00 | 19 | 13.68 | 2.736 | $24.00 | $0.46 |
| CIM.2.b.i | 950 | 16 | 67.86 | 26 | 24.70 | 4.94 | $14.00 | $0.36 |
| CIM.3.a.i | 1200 | 5 | 42.86 | 10 | 12.00 | 2.4 | $28.00 | $0.28 |
| | | | | | 500.02 | 100.00 | | $11.04 |

FIG. 11B shows a comparison 1150 of a scaled objective value of a set of selected CIM records with historical data to the scaled objective value of TB2, according to an embodiment. Three historical CME transactions are displayed, matching the data in Table 11: transaction x 1105, transaction y 1110, and transaction z 1115, along with the scaled objective value of TB2 1160. Curve 1155 indicates the OV per unit cost for each transaction shown. The AM finds that while the average OV/price of the previous CME Transaction z 1115 is still a bit higher than TB2 1160, TB2 is now reasonably in line with the statistical average of previous transactions. AM 138 therefore accepts TB2 as the Final Batch 770 for the current CME Transaction at block 765.

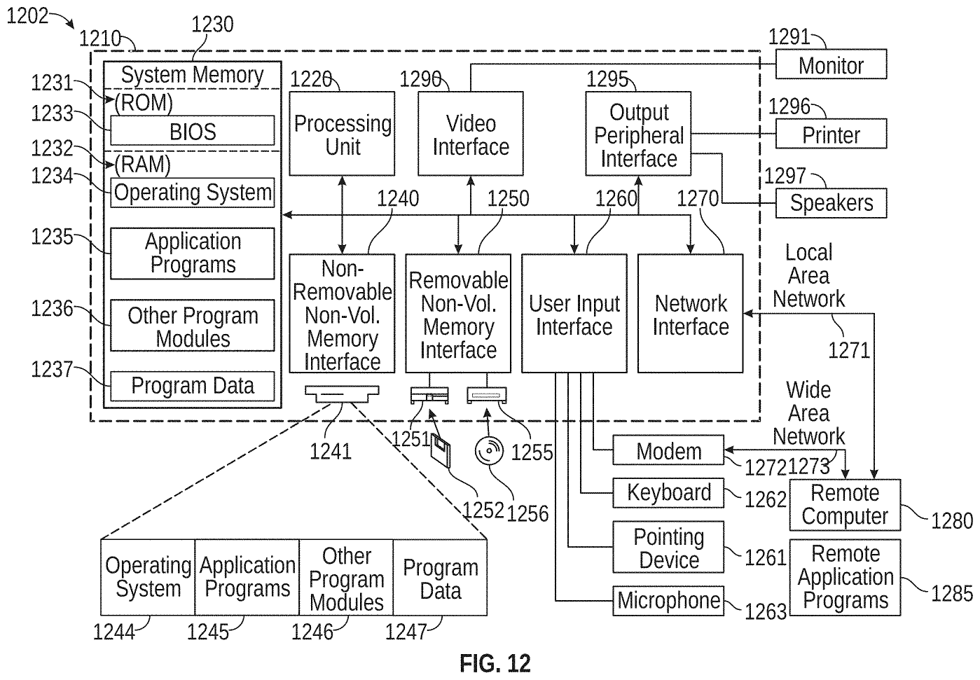

FIG. 12 is a diagram of an example computing system that may be used with some embodiments of the present invention. The computing system 1202 may be used by a User to transmit user data to be stored in a storage area associated with a multi-tenant database environment. For example, the multi-tenant database environment may be associated with the services provided by Salesforce.com®. The computing system 1202 may also be used to retrieve the user data from the storage area.

The computing system 1202 is only one example of a suitable computing system, such as a mobile computing system, and is not intended to suggest any limitation as to the scope of use or functionality of the design. Neither should the computing system 1202 be interpreted as having any dependency or requirement relating to any one or combination of components illustrated. The design is operational with numerous other general purpose or special purpose computing systems. Examples of well-known computing systems, environments, and/or configurations that may be suitable for use with the design include, but are not limited to, personal computers, server computers, hand-held or laptop devices, multiprocessor systems, microprocessor-based systems, set top boxes, programmable consumer electronics, mini-computers, mainframe computers, distributed computing environments that include any of the above systems or devices, and the like. For example, the computing system 1202 may be implemented as a mobile computing system such as one that is configured to run with an operating system (e.g., iOS) developed by Apple Inc. of Cupertino, Calif. or an operating system (e.g., Android) that is developed by Google Inc. of Mountain View, Calif.

Some embodiments of the present invention may be described in the general context of computing system executable instructions, such as program modules, being executed by a computer. Generally, program modules include routines, programs, objects, components, data structures, etc. that performs particular tasks or implement particular abstract data types. Those skilled in the art can implement the description and/or figures herein as computer-executable instructions, which can be embodied on any form of computing machine readable media discussed below.

Some embodiments of the present invention may also be practiced in distributed computing environments where tasks are performed by remote processing devices that are linked through a communications network. In a distributed computing environment, program modules may be located in both local and remote computer storage media including memory storage devices.

Referring to FIG. 12, the computing system 1202 may include, but are not limited to, a processing unit 1220 having one or more processing cores, a system memory 1230, and a system bus 1221 that couples various system components including the system memory 1230 to the processing unit 1220. The system bus 1221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

The computing system 1202 typically includes a variety of computer readable media. Computer readable media can be any available media that can be accessed by computing system 1202 and includes both volatile and nonvolatile media, removable and non-removable media. By way of example, and not limitation, computer readable media may store information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing system 1202. Communication media typically embodies computer readable instructions, data structures, or program modules.

The system memory 1230 may include computer storage media in the form of volatile and/or nonvolatile memory such as read only memory (ROM) 1231 and random access memory (RAM) 1232. A basic input/output system (BIOS) 1233, containing the basic routines that help to transfer information between elements within computing system 1202, such as during start-up, is typically stored in ROM 1231. RAM 1232 typically contains data and/or program modules that are immediately accessible to and/or presently being operated on by processing unit 1220. By way of example, and not limitation, FIG. 12 also illustrates operating system 1234, application programs 1235, other program modules 1236, and program data 1237.

The computing system 1202 may also include other removable/non-removable volatile/nonvolatile computer storage media. By way of example only, FIG. 12 also illustrates a hard disk drive 1241 that reads from or writes to non-removable, nonvolatile magnetic media, a magnetic disk drive 1251 that reads from or writes to a removable, nonvolatile magnetic disk 1252, and an optical disk drive 1255 that reads from or writes to a removable, nonvolatile optical disk 1256 such as, for example, a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 1241 is typically connected to the system bus 1221 through a non-removable memory interface such as interface 1240, and magnetic disk drive 1251 and optical disk drive 1255 are typically connected to the system bus 1221 by a removable memory interface, such as interface 1250.

The drives and their associated computer storage media discussed above and illustrated in FIG. 12, provide storage of computer readable instructions, data structures, program modules and other data for the computing system 1202. In FIG. 12, for example, hard disk drive 12412 is illustrated as storing operating system 1244, application programs 1245, other program modules 1246, and program data 1247. Note that these components can either be the same as or different from operating system 1234, application programs 1235, other program modules 1236, and program data 1237. The operating system 1244, the application programs 1245, the other program modules 1246, and the program data 1247 are given different numeric identification here to illustrate that, at a minimum, they are different copies.

A user may enter commands and information into the computing system 1202 through input devices such as a keyboard 1262, a microphone 1263, and a pointing device 12612, such as a mouse, trackball or touchpad or touch screen. Other input devices (not shown) may include a joystick, gamepad, scanner, or the like. These and other input devices are often connected to the processing unit 1220 through a user input interface 1260 that is coupled with the system bus 1221, but may be connected by other interface and bus structures, such as a parallel port, game port or a universal serial bus (USB). A monitor 1291 or other type of display device is also connected to the system bus 1221 via an interface, such as a video interface 1290. In addition to the monitor, computers may also include other peripheral output devices such as speakers 1297 and printer 1296, which may be connected through an output peripheral interface 1290.

The computing system 1202 may operate in a networked environment using logical connections to one or more remote computers, such as a remote computer 1280. The remote computer 1280 may be a personal computer, a hand-held device, a server, a router, a network PC, a peer device or other common network node, and typically includes many or all of the elements described above relative to the computing system 1202. The logical connections depicted in FIG. 12 include a local area network (LAN) 12712 and a wide area network (WAN) 1273, but may also include other networks. Such networking environments are commonplace in offices, enterprise-wide computer networks, intranets and the Internet.

When used in a LAN networking environment, the computing system 1202 may be connected to the LAN 1271 through a network interface or adapter 1270. When used in a WAN networking environment, the computing system 1202 typically includes a modem 1272 or other means for establishing communications over the WAN 1273, such as the Internet. The modem 1272, which may be internal or external, may be connected to the system bus 1221 via the user-input interface 1260, or other appropriate mechanism. In a networked environment, program modules depicted relative to the computing system 1202, or portions thereof, may be stored in a remote memory storage device. By way of example, and not limitation, FIG. 12 illustrates remote application programs 1285 as residing on remote computer 1280. It will be appreciated that the network connections shown are exemplary and other means of establishing a communications link between the computers may be used.

It should be noted that some embodiments of the present invention may be carried out on a computing system such as that described with respect to FIG. 12. However, some embodiments of the present invention may be carried out on a server, a computer devoted to message handling, handheld devices, or on a distributed system in which different portions of the present design may be carried out on different parts of the distributed computing system.

Another device that may be coupled with the system bus 1271 is a power supply such as a battery or a Direct Current (DC) power supply) and Alternating Current (AC) adapter circuit. The DC power supply may be a battery, a fuel cell, or similar DC power source that needs to be recharged on a periodic basis. The communication module (or modem) 1272 may employ a Wireless Application Protocol (WAP) to establish a wireless communication channel. The communication module 1272 may implement a wireless networking standard such as Institute of Electrical and Electronics Engineers (IEEE) 802.1212 standard, IEEE std. 802.1212-12999, published by IEEE in 12999.

Examples of mobile computing systems may be a laptop computer, a tablet computer, a Netbook, a smart phone, a personal digital assistant, or other similar device with on board processing power and wireless communications ability that is powered by a Direct Current (DC) power source that supplies DC voltage to the mobile computing system and that is solely within the mobile computing system and needs to be recharged on a periodic basis, such as a fuel cell or a battery.

In a networked environment, program modules depicted relative to the hardware device 1202, or portions thereof, may be stored in a remote storage device, such as, for example, on a server. It will be appreciated that other hardware and/or software to establish a communications link between the hardware device 1202 and other devices may be used.

It should be understood that the arrangement of hardware device 1202 illustrated in FIG. 12 is but one possible implementation and that other arrangements are possible. It should also be understood that the various system components (and means) defined by the claims, described above, and illustrated in the various block diagrams represent logical components that are configured to perform the functionality described herein. For example, one or more of these system components (and means) can be realized, in whole or in part, by at least some of the components illustrated in the arrangement of hardware device 1202.

In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 8.

Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

The subject matter has been described herein with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

For purposes of the present description, the terms “component,” “module,” and “process,” may be used interchangeably to refer to a processing unit that performs a particular function and that may be implemented through computer program code (software), digital or analog circuitry, computer firmware, or any combination thereof.

It should be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

In the description herein, numerous specific details are set forth in order to provide a thorough understanding of the disclosure. It will be evident, however, to one of ordinary skill in the art, that the disclosure may be practiced without these specific details. In other instances, well-known structures and devices are shown in block diagram form to facilitate explanation. The description of a preferred embodiment is not intended to limit the scope of the claims appended hereto. Further, in the methods disclosed herein, various steps are disclosed illustrating some of the functions of the disclosure. One will appreciate that these steps are merely exemplary and are not meant to be limiting in any way. Other steps and functions may be contemplated without departing from this disclosure.

What is claimed is:

1. A method comprising:
receiving, by a processor of a computer having memory, a plurality of requests for climate impacting measures (CIMs), each request originating from a different requesting entity, and each request being associated with an emissions value;
aggregating, by the processor, the plurality of requests into a batch, the batch having an emissions value equal to the sum of the individual emissions values of the plurality of requests;
applying a trained model to the aggregated plurality of requests to select CIM records and amounts associated with each selected CIM record, the selecting by the trained model optimizing an offset value of each selected CIM record in view of a cost associated with each selected CIM record, the selecting being based on CIM allocation rules and the batch emissions value, the selected CIM records being from a database of CIM records;
allocating, by the processor, the selected CIM records to the requesting entities based on the emissions value and user preferences associated with each request; and
transmitting, by the processor, responses to each received request of the plurality of requests, the responses each including a message for display on a graphic interface describing the allocated selected records for the requesting entity associated with the request.

2. The method of claim 1, each request further including the user preferences associated with the requesting entity, the user preferences being based on data describing a region, a type of offset, and a method of offset, the user preferences further being used to adjust the selecting of the CIM records and amounts.

3. The method of claim 1, further comprising:
receiving a new CIM record for inclusion into the database of CIM records;
evaluating the new CIM record based on a plurality of factors and a set of CIM evaluation rules; and
adding the new CIM record to the database of CIM records when both the plurality of factors and the set of CIM evaluation rules are satisfied.

4. The method of claim 3, the plurality of factors comprising an offset value, an integrity score, an impact factor, and a failure factor, the plurality of factors being satisfied when each value of the new CIM record for the plurality of factors satisfies a predetermined threshold value.

5. The method of claim 1, each request including one or more of a list of activities or an emissions value to offset, or an amount of meta carbon credits to purchase.

6. The method of claim 5, further comprising determining an emissions value associated with the included list of activities or amount of emissions or meta carbon credits, and adding the emissions values included in the request to determine the emissions value associated with the request.

7. The method of claim 1, the user preferences comprising values associated with one or more of a type of offset, a region, or a method of offset.

8. The method of claim 1, the trained model selecting the CIM records and the amounts associated with each selected CIM record by:
filtering the database of CIM records to omit CIM records not capable of meeting the CIM allocation rules;
selecting a first set of CIM records using the trained model, the selection of the first set optimizing an offset value of each CIM record in the first set in view of a cost associated with each CIM record in the first set, the first set of CIM records having an aggregate objective value;
evaluating the first set of CIM records in view of penalty functions, the evaluating comprising assessing a penalty value to the first set of records for each penalty function violated;
scaling the objective value of the first set of CIM records based on a sum of penalty values for the first set of CIM records; and
re-selecting CIM records to generate a second set of CIM records when the scaled objective value of the first set of CIM records is less than a predetermined threshold, the second set of CIM records being the selected CIM records when a scaled objective value of the second set of CIM records is greater than the predetermined threshold.

9. The method of claim 8, further comprising comparing the scaled objective value of the second set of CIM records to historical objective values of similar CIM record groups, the trained model being re-run when the scaled objective value of the second set of CIM records is more than a predetermined threshold less than the historical objective values of similar CIM record groups.

10. A computer program product comprising computer-readable program code to be executed by one or more processors when retrieved from a non-transitory computer-readable medium, the program code including instructions to:
receive a plurality of requests for climate impacting measures (CIMs), each request originating from a different requesting entity, and each request being associated with an emissions value;
aggregate the plurality of requests into a batch, the batch having an emissions value equal to the sum of the individual emissions values of the plurality of requests;
apply a trained model to the aggregated plurality of requests to select CIM records and amounts associated with each selected CIM record, the selecting by the trained model optimizing an offset value of each selected CIM record in view of a cost associated with each selected CIM record, the selecting being based on CIM allocation rules and the batch emissions value, the selected CIM records being from a database of CIM records;
allocate the selected CIM records to the requesting entities based on the emissions value and user preferences associated with each request; and
transmit responses to each received request of the plurality of requests, the responses each including a message for display on a graphic interface describing the allocated selected records for the requesting entity associated with the request.

11. The computer program product of claim 10, each request further including the user preferences associated with the requesting entity, the user preferences being based on data describing a region, a type of offset, and a method of offset, the user preferences further being used to adjust the selecting of the CIM records and amounts.

12. The computer program product of claim 10, the computer program product further comprising instructions to:
receive a new CIM record for inclusion into the database of CIM records;
evaluate the new CIM record based on a plurality of factors and a set of CIM evaluation rules; and
add the new CIM record to the database of CIM records when both the plurality of factors and the set of CIM evaluation rules are satisfied.

13. The computer program product of claim 12, the plurality of factors comprising an offset value, an integrity score, an impact factor, and a failure factor, the plurality of factors being satisfied when each value of the new CIM record for the plurality of factors satisfies a predetermined threshold value.

14. The computer program product of claim 10, each request including one or more of a list of activities or an emissions value to offset, or an amount of meta carbon credits to purchase.

15. The computer program product of claim 14, the computer program product further comprising instructions to determine an emissions value associated with the included list of activities or amount of emissions or meta carbon credits, and adding the emissions values included in the request to determine the emissions value associated with the request.

16. The computer program product of claim 10, the user preferences comprising values associated with one or more of a type of offset, a region, or a method of offset.

17. The computer program product of claim 10, the trained model selecting the CIM records and the amounts associated with each selected CIM record by:
filtering the database of CIM records to omit CIM records not capable of meeting each the CIM allocation rules;
selecting a first set of CIM records using the trained model, the selection of the first set optimizing an offset value of each CIM record in the first set in view of a cost associated with each CIM record in the first set, the first set of CIM records having an aggregate objective value;
evaluating the first set of CIM records in view of penalty functions, the evaluating comprising assessing a penalty value to the first set of records for each penalty function violated;
scaling the objective value of the first set of CIM records based on a sum of penalty values for the first set of CIM records; and
re-selecting CIM records to generate a second set of CIM records when the scaled objective value of the first set of CIM records is less than a predetermined threshold, the second set of CIM records being the selected CIM records when a scaled objective value of the second set of CIM records is greater than the predetermined threshold.

18. The computer program product of claim 17, the computer program product further comprising instructions to compare the scaled objective value of the second set of CIM records to historical objective values of similar CIM record groups, the trained model being re-run when the scaled objective value of the second set of CIM records is more than a predetermined threshold less than the historical objective values of similar CIM record groups.

19. A system comprising:
one or more processors; and
a non-transitory computer readable medium storing a plurality of instructions, which
when executed, cause the one or more processors to:
receive a plurality of requests for climate impacting measures (CIMs), each request originating from a different requesting entity, and each request being associated with an emissions value;
aggregate the plurality of requests into a batch, the batch having an emissions value equal to the sum of the individual emissions values of the plurality of requests;
apply a trained model to the aggregated plurality of requests to select CIM records and amounts associated with each selected CIM record, the selecting by the trained model optimizing an offset value of each selected CIM record in view of a cost associated with each selected CIM record, the selecting being based on CIM allocation rules and the batch emissions value, the selected CIM records being from a database of CIM records;
allocate the selected CIM records to the requesting entities based on the emissions value and user preferences associated with each request; and
transmit responses to each received request of the plurality of requests, the responses each including a message for display on a graphic interface describing the allocated selected records for the requesting entity associated with the request.
